(19) United States
(12) Patent Application Publication
(10) Pub. No.: US 2025/0203237 A1
(43) Pub. Date: Jun. 19, 2025

(54) LIGHT RECEIVING ELEMENT AND ELECTRONIC DEVICE

(71) Applicant: SONY SEMICONDUCTOR SOLUTIONS CORPORATION, KANAGAWA (JP)

(72) Inventor: YUTA SHIMANUKI, KANAGAWA (JP)

(21) Appl. No.: 18/848,547

(22) PCT Filed: Mar. 14, 2023
(86) PCT No.: PCT/JP2023/009779

§ 371 Date: Sep. 19, 2024

(30) Foreign Application Priority Data
Mar. 30, 2022 (JP) 2022-055995

(51) Int. Cl. H04N 25/705; H04N 25/47

(52) U.S. Cl. CPC H04N 25/705; H04N 25/47

(57) ABSTRACT

The present technology relates to a light receiving element and an electronic device that can downsize a light receiving element that performs distance measurement. Included are a pixel array unit in which pixels each including a photoelectric conversion unit are arranged in a matrix; and a charge holding unit that holds charges from the photoelectric conversion unit. In each of the pixels, a first charge holding unit in which a signal based on the held charges is used to calculate distance measurement information and a second charge holding unit in which the signal is not used to calculate distance measurement information are arranged. The present technology can be applied to a light receiving element that performs distance measurement.

### TECHNICAL FIELD

The present technology relates to a light receiving element and an electronic device, and more particularly, to a light receiving element and an electronic device that are suitable for use, for example, in a distance measuring device.

### BACKGROUND ART

A distance measuring device using an indirect time of flight (ToF) method is known. In the distance measuring device using the indirect ToF method, light is emitted toward an object, and the reflected light, which returns by being reflected by the surface of the object, is received by a light receiving element. The light receiving element has a configuration in which one photodiode and two gates are arranged in a pixel. The gates of this light receiving element are alternately switched on and off to distribute electric charges generated in the photodiode, and the distance is calculated from the ratio of the distributed electric charges (e.g., see PTL 1).

### CITATION LIST

### Patent Literature

[PTL 1]
JP 2021-97214A

### SUMMARY

### Technical Problem

It has been difficult to miniaturize a light receiving element because, a plurality of transistors and a storage unit that stores charges from the photodiode are arranged, in addition to a photodiode.

The present technology has been made in light of such a situation and aims at making it possible to downsize a light receiving element that performs distance measurement.

### Solution to Problem

A first light receiving element according to one aspect of the present technology is a light receiving element including: a pixel array unit in which pixels each including a photoelectric conversion unit are arranged in a matrix; and a charge holding unit that holds charges from the photoelectric conversion unit, wherein, in each of the pixels, a first charge holding unit in which a signal based on the held charges is used to calculate distance measurement information and a second charge holding unit in which the signal is not used to calculate distance measurement information are arranged.

A first electronic device according to one aspect of the present technology is an electronic device including: a light receiving element that includes a pixel array unit in which pixels each including a photoelectric conversion unit are arranged in a matrix, and a charge holding unit that holds charges from the photoelectric conversion unit, wherein, in each of the pixels, a first charge holding unit in which a signal based on the held charges is used to calculate distance measurement information and a second charge holding unit in which the signal is not used to calculate distance measurement information are arranged; and a processing unit that processes a signal from the light receiving element.

A second light receiving element according to one aspect of the present technology is a light receiving element including: a pixel array unit in which pixels each including a photoelectric conversion unit are arranged in a matrix; and a charge holding unit that holds charges from the photoelectric conversion unit, wherein the charge holding unit is shared by the photoelectric conversion units adjacent to each other, and in the pixel array unit, first charge holding units each configured of one region and second charge holding units each configured of two regions are arranged alternately.

A second electronic device according to one aspect of the present technology is an electronic device including: a light receiving element that includes a pixel array unit in which pixels each including a photoelectric conversion unit are arranged in a matrix; and a charge holding unit that holds charges from the photoelectric conversion unit, wherein the charge holding unit is shared by the photoelectric conversion units adjacent to each other, and in the pixel array unit, first charge holding units each configured of one region and second charge holding units each configured of two regions are arranged alternately; and a processing unit that processes a signal from the light receiving element.

A third light receiving element according to one aspect of the present technology is a light receiving element including: a pixel array unit in which pixels each including a photoelectric conversion unit are arranged in a matrix; and a charge holding unit that holds charges from the photoelectric conversion unit, wherein the charge holding unit is shared by the photoelectric conversion units adjacent to each other and is configured of two regions.

A third electronic device according to one aspect of the present technology is an electronic device including: a light receiving element that includes a pixel array unit in which pixels each including a photoelectric conversion unit are arranged in a matrix, and a charge holding unit that holds charges from the photoelectric conversion unit, wherein the charge holding unit is shared by the photoelectric conversion units adjacent to each other and is configured of two regions; and a processing unit that processes a signal from the light receiving element.

A first light receiving element according to one aspect of the present technology includes: a pixel array unit in which pixels each including a photoelectric conversion unit are arranged in a matrix; and a charge holding unit that holds charges from the photoelectric conversion unit, wherein, in each of the pixels, a first charge holding unit in which a signal based on the held charges is used to calculate distance measurement information and a second charge holding unit in which the signal is not used to calculate distance measurement information are arranged.

A first electronic device according to one aspect of the present technology includes the first light receiving element.

A second light receiving element according to one aspect of the present technology includes: a pixel array unit in which pixels each including a photoelectric conversion unit are arranged in a matrix; and a charge holding unit that holds charges from the photoelectric conversion unit, wherein the charge holding unit is shared by the photoelectric conversion units adjacent to each other, and in the pixel array unit, first charge holding units each configured of one region and second charge holding units each configured of two regions are arranged alternately.

A second electronic device according to one aspect of the present technology includes the second light receiving element.

A third light receiving element according to one aspect of the present technology includes: a pixel array unit in which pixels each including a photoelectric conversion unit are arranged in a matrix; and a charge holding unit that holds charges from the photoelectric conversion unit, wherein the charge holding unit is shared by the photoelectric conversion units adjacent to each other and is configured of two regions.

A third electronic device according to one aspect of the present technology includes the third light receiving element.

The electronic device may be an independent device or an internal block constituting a single device.

### BRIEF DESCRIPTION OF DRAWINGS

FIG. 1 is a block diagram illustrating a configuration of an embodiment of a light receiving element to which the present technology is applied.

FIG. 2 is a diagram illustrating a planar configuration example of pixels.

FIG. 3 is a diagram illustrating a cross-sectional configuration example of the pixels.

FIG. 4 is a diagram illustrating an operation of pixels.

FIG. 5 illustrates calculation of distance measurement information.

FIG. 6 is a diagram illustrating a configuration example of pixels according to a second embodiment.

FIG. 7 is a diagram illustrating a configuration example of pixels according to a third embodiment.

FIG. 8 is a diagram illustrating an arrangement of pixels.

FIG. 9 is a diagram illustrating a configuration example of pixels according to a fourth embodiment.

FIG. 10 is a diagram illustrating an operation of pixels.

FIG. 11 is a diagram illustrating a configuration example of pixels according to a fifth embodiment.

FIG. 12 is a diagram illustrating a configuration example of pixels according to a sixth embodiment.

FIG. 13 is a diagram illustrating an operation of pixels.

FIG. 14 is a diagram illustrating a configuration example of pixels according to a seventh embodiment.

FIG. 15 is a diagram illustrating an operation of pixels.

FIG. 16 is a diagram illustrating a configuration example of pixels according to an eighth embodiment.

FIG. 17 is a diagram illustrating a configuration example of pixels according to a ninth embodiment.

FIG. 18 is a diagram illustrating a configuration example of pixels according to a tenth embodiment.

FIG. 19 is a block diagram illustrating a configuration example of a distance measurement module to which the present technology is applied.

FIG. 20 is a block diagram illustrating a configuration example of a smartphone as an electronic device to which the present technology is applied.

FIG. 21 is a block diagram illustrating an example of a schematic configuration of a vehicle control system.

FIG. 22 is an explanatory diagram illustrating an example of installation positions of vehicle exterior information detection units and imaging units.

### DESCRIPTION OF EMBODIMENTS

Hereinafter, modes for carrying out the present technology (hereinafter referred to as “embodiments”) will be described.

In drawings to be referred to in the following description, same or similar portions are denoted by same or similar reference signs. However, the drawings are schematic and relationships between thicknesses and plan view dimensions, ratios of thicknesses of respective layers, and the like differ from those in real. In addition, drawings include portions where dimensional relationships and ratios differ between the drawings in some cases.

It is to be understood that definitions of directions such as upward, downward, and the like in the following description are merely definitions provided for the convenience of explanation and are not intended as limiting technical ideas of the present disclosure. For example, when an object is observed after being rotated by 90 degrees, up-down is converted into and interpreted as left-right, and when an object is observed after being rotated by 180 degrees, up-down is interpreted as being inverted.

### Configuration Example of Light Receiving Element

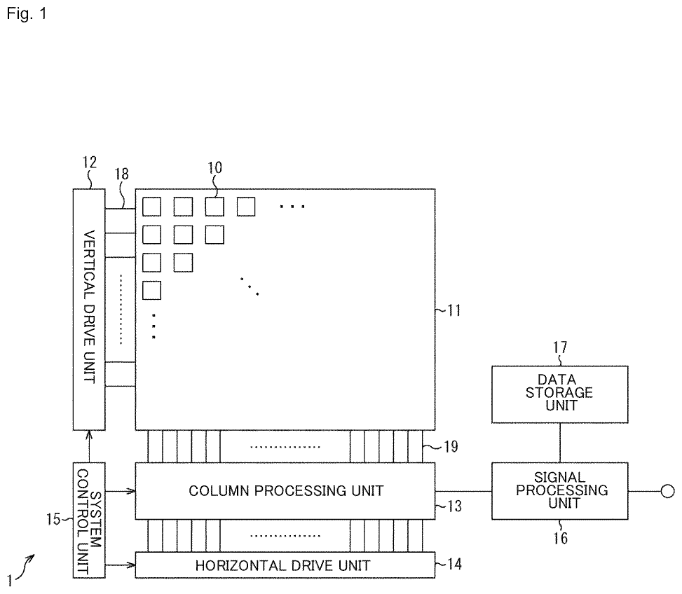

FIG. 1 is a block diagram illustrating a configuration of an embodiment of a light receiving element to which the present technology is applied.

A light receiving element 1 illustrated in FIG. 1 is a distance measurement sensor that outputs distance measurement information by the indirect ToF method. The light receiving element 1 receives light (reflected light) obtained by reflection of light emitted from a predetermined light source (irradiation light) and hitting against an object, and outputs a depth image in which information on a distance to the object is stored as depth values. The irradiation light emitted from the light source is infrared light with a wavelength of equal to or greater than 780 nm, for example, and is pulse light that repeatedly turns on and off at a predetermined cycle.

The light receiving element 1 includes a pixel array unit 11 formed on a semiconductor substrate, which is not illustrated, and peripheral circuit units. The peripheral circuit units include, for example, a vertical drive unit 12, a column processing unit 13, a horizontal drive unit 14, a system control unit 15, and so on.

The light receiving element 1 is further provided with a signal processing unit 16 and a data storage unit 17. The signal processing unit 16 and the data storage unit 17 may be mounted on the same substrate as that of the light receiving element 1, and may be disposed on a substrate in a module different from that of the light receiving element 1.

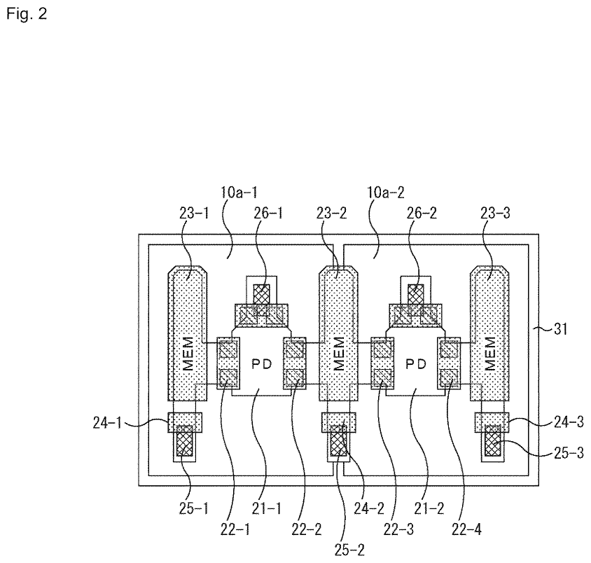

The pixel array unit 11 generates an electric charge corresponding to an amount of received light and has a configuration in which pixels 10 to output a signal corresponding to the electric charge are arrayed in a matrix in a row direction and a column direction. In other words, the pixel array unit 11 includes a plurality of pixels 10 that photoelectrically convert incident light and that outputs a signal in accordance with an electric charge obtained as a result of the photoelectric conversion. Details of the pixels 10 will be described later in FIG. 2 and the subsequent figures.

In this case, the row direction refers to an array direction of the pixels 10 in the horizontal direction and the column direction refers to an array direction of the pixels 10 in the vertical direction. The row direction is a transverse direction in the figure, and the column direction is a longitudinal direction in the figure.

In the pixel array unit 11, with respect to the matrix pixel array, a pixel drive line 18 is wired in the row direction for each pixel row, and two vertical signal lines 19 are wired in the column direction for each pixel column. For example, the pixel drive line 18 transmits a drive signal for driving at the time of reading of a signal from the pixel 10. While one wire is illustrated for the pixel drive line 18 in FIG. 1, the number of wires is not limited to one. One end of the pixel drive line 18 is connected to an output end of the vertical drive unit 12 corresponding to each row.

The vertical drive unit 12 is configured by a shift register, an address decoder, or the like, and drives each of the pixels 10 of the pixel array unit 11 at the same time, on a per-row basis, or the like. In other words, along with the system control unit 15 that controls the vertical drive unit 12, the vertical drive unit 12 configures a control circuit that controls an operation of each pixel 10 of the pixel array unit 11.

Pixel signals output from the pixels 10 in a pixel row in response to drive control by the vertical drive unit 12 are input to the column processing unit 13 through the corresponding vertical signal lines 19. The column processing unit 13 performs predetermined signal processing on the pixel signals output from the pixels 10 through the vertical signal lines 19, and temporarily holds the pixel signals after the signal processing. Specifically, the column processing unit 13 performs noise removal processing, analog to digital (AD) conversion processing, and the like as the signal processing.

The horizontal drive unit 14 is configured by a shift register, an address decoder, or the like, and sequentially selects unit circuits corresponding to pixel columns in the column processing unit 13. Through selective scanning by the horizontal drive unit 14, pixel signals subjected to the signal processing for each unit circuit in the column processing unit 13 are sequentially output.

The system control unit 15 is configured by a timing generator for generating various timing signals or the like, and performs drive control of the vertical drive unit 12, the column processing unit 13, the horizontal drive unit 14, and the like, based on the various timing signals generated by the timing generator.

The signal processing unit 16 has at least an arithmetic operation processing function, and performs various kinds of signal processing such as arithmetic operation processing based on the pixel signals output from the column processing unit 13. The data storage unit 17 temporarily stores data required for signal processing performed by the signal processing unit 16 when the signal processing is performed.

The light receiving element 1 configured as described above has a circuit configuration called column ADC in which an AD conversion circuit that performs AD conversion processing is arranged for each pixel column in the column processing unit 13.

The light receiving element 1 outputs a depth image in which information on the distance to the object is stored as a depth value in a pixel value. The light receiving element 1 is mounted in a vehicle, for example, is mounted in an in-vehicle system for measuring the distance to an object outside the vehicle, or is mounted on a smartphone or the like and is used for gesture recognition processing or the like of measuring the distance to an object such as a user's hand and recognizing a user's gesture based on a measurement result.

### <Plan View of Pixel>

FIG. 2 is a diagram illustrating a planar configuration example of pixels 10. A transverse direction in FIG. 2 corresponds to a row direction (horizontal direction) in FIG. 1, and a longitudinal direction corresponds to a column direction (vertical direction) in FIG. 1. The pixels 10 illustrated in FIG. 2 are referred to as pixels 10a according to a first embodiment.

FIG. 2 illustrates an example of a configuration of pixels 10a-1 and 10a-2 adjacent to each other in the transverse direction. In the following description, if there is no need to distinguish between the pixel 10a-1 and the pixel 10a-2, they will simply be referred to as pixels 10a. Other parts will be described in the same manner.

As illustrated in FIG. 2, a PD 21-1 is formed in the central region of the rectangular pixel 10a-1. A first transfer transistor 22-1 is provided to the left of the PD 21-1 in the figure, and a charge holding unit (MEM) 23-1 is provided at a position via the first transfer transistor 22-1. When the first transfer transistor 22-1 is turned on, the charges stored in the PD 21-1 are transferred to the charge holding unit 23-1.

A second transfer transistor 24-2 is provided below the charge holding unit 23-1 in the figure, and a floating diffusion (FD) 25-1 is provided at a position via the second transfer transistor 24-2. When the second transfer transistor 24-1 is turned on, the charges stored in the charge holding unit 23-1 are transferred to the FD 25-1.

Although not illustrated in FIG. 2, there are also provided an amplifier transistor 27-1 that reads out a signal from the FD 25-1, a selection transistor 28-1 that outputs the signal amplified by the amplifier transistor 27-1 to the column processing unit 13 via the vertical signal line 19, and a reset transistor 29-1 that resets the FD 25-1. A charge discharge transistor 26-1 is provided above the PD 21-1 in the figure.

The plan views illustrated in FIG. 2 and other figures only illustrate parts necessary for the explanation. The pixel 10 may have a stacked structure, and may have, for example, a configuration in which a PD 21 and a charge holding unit 23 are formed in separate layers and stacked, or a configuration in which transistors such as the amplifier transistor 27-1 and the selection transistor 28-1 are formed in separate layers and stacked.

A first transfer transistor 22-2 is provided to the right of the PD 21-1 in the figure, and a charge holding unit 23-2 is provided at a position via the first transfer transistor 22-2. When the first transfer transistor 22-2 is turned on, the charges stored in the PD 21-1 are transferred to the charge holding unit 23-2.

A second transfer transistor 24-2 is provided below the charge holding unit 23-2 in the figure, and an FD 25-2 is provided at a position via the second transfer transistor 24-2. When the second transfer transistor 24-2 is turned on, the charges stored in the charge holding unit 23-2 are transferred to the FD 25-2.

Although not illustrated in FIG. 2, there are also provided an amplifier transistor 27-2 that reads out a signal from the FD 25-2, a selection transistor 28-2 that outputs the signal amplified by the amplifier transistor 27-2 to the column processing unit 13 via the vertical signal line 19, and a reset transistor 29-2 that resets the FD 25-2.

The pixel 10a-1 has such a configuration. The pixel 10a-2 has the same configuration as the pixel 10a-1.

As illustrated in FIG. 2, a PD 21-2 is formed in the central region of the rectangular pixel 10a-2. A first transfer transistor 22-2 is provided to the left of the PD 21-2 in the figure, and the charge holding unit 23-2 is provided at a position via the first transfer transistor 22-2. When the first transfer transistor 22-2 is turned on, the charges stored in the PD 21-2 are transferred to the charge holding unit 23-2.

The pixels 10a illustrated in FIG. 2 have a configuration in which the two pixels 10a share the charge holding unit 23 disposed between the pixels 10a. The charge holding unit 23-2 has a configuration in which it is shared by the pixel 10a-1 (PD 21-1) and the pixel 10a-2 (PD 21-2).

When the first transfer transistor 22-2, which transfers the charges of the PD 21-1, is turned on, the charges from the PD 21-1 are transferred to and held in the charge holding unit 23-2. Also with the configuration, when a first transfer transistor 22-3, which transfers the charges of the PD 21-2, is turned on, the charges from the PD 21-2 are transferred to and held in the charge holding unit 23-2.

Since the charge holding unit 23-2 is configured to be shared, the second transfer transistor 24-2, which transfers to the FD 25-2 the charges held in the charge holding unit 23-2, the FD 25-2, the amplifier transistor 27-2, the selection transistor 28-2, and the reset transistor 29-2 are also configured to be shared.

A first transfer transistor 22-3 is provided to the right of the PD 21-2 included in the pixel 10a-2 in the figure, and a charge holding unit 23-3 is provided at a position via the first transfer transistor 22-3. When the first transfer transistor 22-3 is turned on, the charges stored in the PD 21-2 are transferred to a charge holding unit 23-3.

A second transfer transistor 24-3 is provided below the charge holding unit 23-3 in the figure, and an FD 25-3 is provided at a position via the second transfer transistor 24-3. When the second transfer transistor 24-3 is turned on, the charges stored in the charge holding unit 23-3 are transferred to the FD 25-3.

Although not illustrated in FIG. 2, there are also provided an amplifier transistor 27-3 that reads out a signal from the FD 25-3, a selection transistor 28-3 that outputs the signal amplified by the amplifier transistor 27-3 to the column processing unit 13 via the vertical signal line 19, and a reset transistor 29-3 that resets the FD 25-3. A charge discharge transistor 26-2 is provided above the PD 21-2 in the figure.

Focusing on one pixel 10a, for example, the pixel 10a-1, it has a configuration in which the charge holding unit 23-1 provided exclusively for the photodiode 21-1 is disposed at one side of the photodiode 21-1, and the charge holding unit 23-2 shared by the adjacent photodiode 21-1 and photodiode 21-2 is disposed at the other side.

In the pixel array unit 11, the pixels 10a as illustrated in FIG. 2 are arranged in the vertical and horizontal directions. When viewed from the pixel array unit 11, it has a configuration in which a plurality of charge holding units 23 are provided, and the plurality of charge holding units 23 include a charge holding unit 23 shared by a plurality of pixels 10a (two pixels 10a in this example).

The pixel 10a-1 and the pixel 10a-2 are surrounded by a shallow trench isolation (STI) 31. In addition, the STI 31 is also provided between the pixel 10a-1 and the pixel 10a-2 and is configured to prevent light leakage between the pixels 10a.

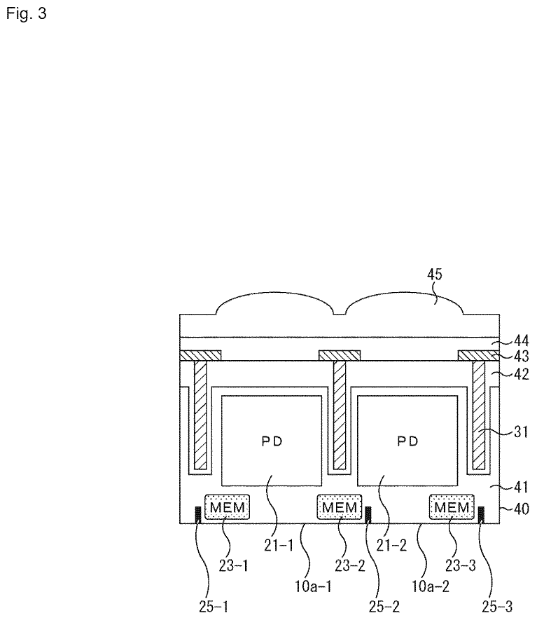

FIG. 3 is a diagram illustrating a cross-sectional configuration example of the pixels 10a. Each pixel 10a has a configuration in which a PD 21 is formed in a semiconductor substrate 40. The semiconductor substrate 40 is made of, for example, silicon (hereinafter, referred to as Si) and is formed to have a thickness of, for example, 1 to 10 μm. In the semiconductor substrate 40, for example, an N-type (second conductivity type) semiconductor region (a rectangular region indicated by PD in FIG. 3) is formed on a per-pixel basis in a P-type (first conductivity type) semiconductor region 41, so that a PD 21 is formed on a per-pixel basis.

The pixel 10a has a configuration in which it is surrounded by the STI 31. The STI 31 has a configuration in which its sides are surrounded by an oxide film 42. The oxide film 42 is also formed on the semiconductor substrate 40 which is the upper side in FIG. 2. The upper surface of the semiconductor substrate 40 in the figure serves as a light incident surface on which light is incident. A light shielding film 43 is formed on the light incident surface of the semiconductor substrate 40 on the STI 31.

The oxide film 42 may have a laminated structure in which a fixed charge film and an oxide film are laminated. As the oxide film 42, a high-dielectric-constant (High-k) thin insulating film based on an atomic layer deposition (ALD) method can be used, for example. Specifically, hafnium oxide (HfO₂), aluminum oxide (Al₂O₃), titanium oxide (TiO₂), strontium titan oxide (STO), or the like can be used.

The light shielding film 43 is provided at a boundary section between adjacent pixels 10a and functions as an inter-pixel light shielding film that prevents incident light from being incident on adjacent pixels. The material of the light shielding film 43 may be any material as long as it blocks light, and a metal material can be used such as tungsten (W), aluminum (Al), or copper (Cu), for example.

A flattened film 44 is formed of an insulating film such as silicon oxide (SiO₂), silicon nitride (SiN), or silicon oxynitride (SiON) or an organic material such as a resin, for example, on the upper surface of the oxide film 42 and the upper surface of the light shielding film 43.

An on-chip lens 45 is formed for each pixel on the upper surface of the flattened film 44. The on-chip lens 45 is formed of, for example, a resin material such as a styrene resin, an acrylic resin, a styrene-acrylic copolymer resin, or a siloxane resin. Light condensed by the on-chip lens 45 is efficiently incident on the PD 21.

The charge holding unit 23-1 for the PD 21-1 is disposed to the lower left of the PD 21-1 in the figure, and the FD 25-1 is disposed to the left of the charge holding unit 23-1 in the figure. The charge holding unit 23-3 for the PD 21-2 is disposed to the lower right of the PD 21-2 in the figure, and the FD 25-3 is disposed to the right of the charge holding unit 23-3 in the figure.

The charge holding unit 23-2, which is shared by the PD 21-1 and the PD 21-2, is disposed on the lower side between PD 21-1 and PD 21-2 in the figure. The FD 25-2 is disposed to the right of the charge holding unit 23-2.

In this manner, focusing on one pixel 10a, the PD 21 is provided in the center of the pixel 10a, and the charge holding units 23 are provided to the left and right of the PD 21, respectively. Focusing on two adjacent pixels 10a, the charge holding unit 23 is provided between the pixels 10a and is shared by the two pixels 10a. With the configuration of the pixels 10a according to the first embodiment, the two pixels 10a have three charge holding units 23.

### Operation of Pixels 10a According to First Embodiment

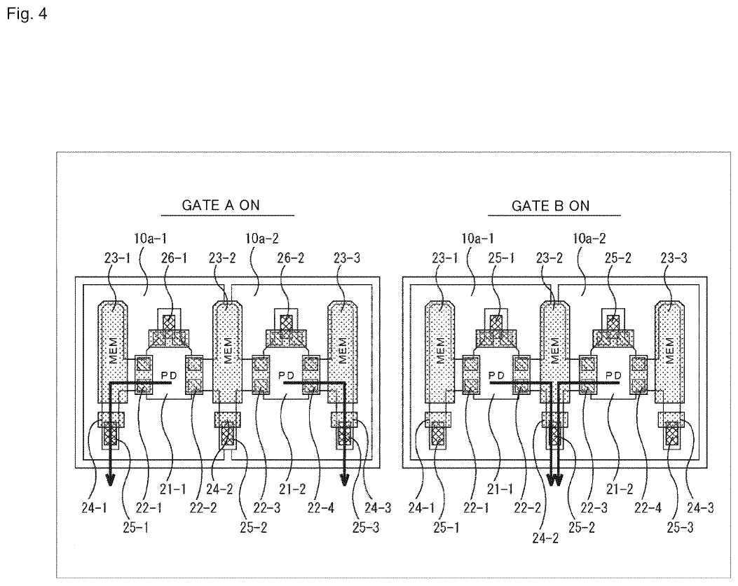

The operation of the pixels 10a, specifically, the operation related to the transfer of charges from the PDs 21 will be described with reference to FIG. 4.

In the following description, the gate of the first transfer transistor 22-1 and the gate of the second transfer transistor 24-2, which are included in the pixel 10a-1, will be referred to as gate A. The gate of the first transfer transistor 22-4 and the gate of the second transfer transistor 24-4, which are included in the pixel 10a-2, are also referred to as gate A. Gate A is a gate that is turned on when charges are transferred to a charge holding unit 23 provided exclusively for a PD 21.

The gate of the first transfer transistor 22-2 and the gate of the second transfer transistor 24-2, which are included in the pixel 10a-1, are referred to as gate B. The gate of the first transfer transistor 22-3 and the gate of the second transfer transistor 24-3, which are included in the pixel 10a-2, are also referred to as gate B. Gate B is a gate that is turned on when charges are transferred to the charge holding unit 23 shared by the two PDs 21.

The left diagram in FIG. 4 is a diagram in which arrows indicating flows of charges when gate A is on are added to the planar configuration example of the pixels 10a illustrated in FIG. 2. The right diagram in FIG. 4 is a diagram in which arrows indicating flows of charges when gate B is on are added to the planar configuration example of the pixels 10a illustrated in FIG. 2.

Refer to the left diagram in FIG. 4, that is, the diagram when gate A is on. When gate A is on, on the pixel 10a-1 side, the charges stored in the PD 21-1 are transferred to the charge holding unit 23-1 via the first transfer transistor 22-1, and further transferred to the FD 25-1 via the second transfer transistor 24-1. When gate A is on, on the pixel 10a-2 side, the charges stored in the PD 21-2 are transferred to the charge holding unit 23-3 via the first transfer transistor 22-4, and further transferred to the FD 25-3 via the second transfer transistor 24-3.

A signal read out when gate A is turned on is used to calculate distance measurement information.

Refer to the right diagram in FIG. 4 when gate Bis on. When gate B is on, on the pixel 10B-1 side, the charges stored in the PD 21-1 are transferred to the charge holding unit 23-2 via the first transfer transistor 22-2, and further transferred to the FD 25-2 via the second transfer transistor 24-2. When gate B is on, on the pixel 10B-2 side, the charges stored in the pixel PD 21-2 are transferred to the charge holding unit 23-2 via the first transfer transistor 22-3, and further transferred to FD 25-2 via the second transfer transistor 24-2.

When gate B is turned on, charges are transferred from both the PD 21-1 and the PD 21-2 to the charge holding unit 23-2. A signal read out when gate B is turned on is not used to calculate distance information and is discarded.

The pixel 10a according to the first embodiment is configured to include a charge holding unit 23 (e.g., the charge holding unit 23-1, 23-3) in which a signal based on the held charges is used to calculate distance measurement information, and a charge holding unit 23 (e.g., the charge holding unit 23-2, 23-4) in which the signal is not used to calculate distance measurement information.

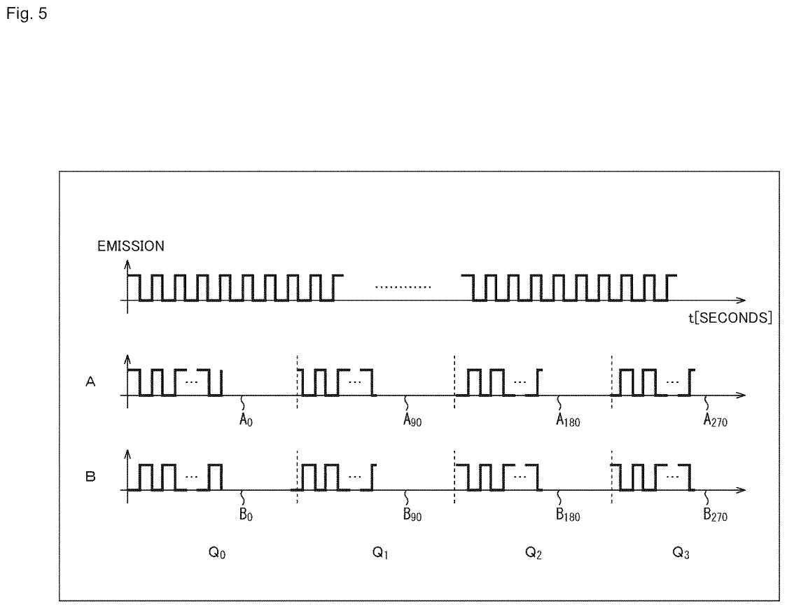

In the pixel 10a, only the signal read out when gate A is on is used to calculate distance measurement information, and the signal read out when gate B is on is not used to calculate distance measurement information. Even when only the signal held in one of the charge holding units 23 is used to calculate distance measurement information, the distance measurement information can be calculated. This will be briefly described with reference to FIG. 5.

As illustrated in FIG. 5, a detection period of one frame will be described as being made up of detection periods Q0, Q1, Q2, and Q3. In the detection period Q0, a detection signal A0 and a detection signal B0 are acquired, and in the detection period Q1, a detection signal A90 and a detection signal B90 are acquired. In the detection period Q2, a detection signal A180 and a detection signal B180 are acquired, and in the detection period Q3, a detection signal A270 and a detection signal B270 are acquired.

The detection signals A are signal acquired when gate A is turned on. The detection signals B are signals acquired when gate B is turned on. In the description with reference to FIG. 5, it is assumed that the detection signals B are signals acquired when only the signal from the PD 21-1 is stored in the charge holding unit 23-2 (FIG. 4), in other words, when processing is performed by a conventional method known as a two-tap method.

Using these detection signals, a phase difference θ is calculated based on the following Equation (1), and a distance D is calculated based on the following Equation (2).

$$\begin{matrix}[ Math . 1 ] & \\ I = {c}_{0} - {c}_{180} = ( {A}_{0} - {B}_{0} ) - ( {A}_{180} - {B}_{180} ) & ( 1 )\end{matrix}$$

$$Q = {c}_{90} - {c}_{270} = ( {A}_{90} - {B}_{90} ) - ( {A}_{270} - {B}_{270} )$$

$$θ = {tan}^{- 1} ( \frac{Q}{1} ) ( 0 \leq θ < 2 π )$$

$$\begin{matrix}[ Math . 2 ] & \\ D = \frac{θ}{2 π} ( \frac{{T}_{P} c}{2} ) & ( 2 )\end{matrix}$$

In Equation (1), I represents a value obtained by subtracting a value C180 obtained by subtracting the detection signal B180 from the detection signal A180 from a value C0 obtained by subtracting the detection signal B0 from the detection signal A0. Q represents a value obtained by subtracting a value C270 obtained by subtracting the detection signal B270 from the detection signal A270 from a value C90 obtained by subtracting the detection signal B90 from the detection signal A90. The phase difference θ is calculated by calculating an arc tangent of (I/Q).

In Equation (2), C denotes the velocity of light and Tp denotes a pulse width. A delay time Td can be calculated based on the phase difference θ, and the distance D to the object can be calculated based on the delay time Td. In this way, a distance to a predetermined object can be measured using four beams of light with different phase differences.

Here, the detection signal B0, the detection signal B1, the detection signal B2, and the detection signal B3 are set to 0. This corresponds to the case where distance measurement information is calculated without using the signal stored in charge holding unit 23-2, as described with reference to FIG. 4. Even if the detection signals B are set to 0, I and Q in Equation (1) can be calculated, the phase difference θ can also be calculated, and therefore, it is clear that the distance D can be calculated in Equation (2).

Thus, even in the case of using a two-tap method, it is possible to acquire distance measurement information using a signal from only one tap. As described with reference to FIG. 4, this means that distance measurement information can be calculated using only the signal obtained when gate A is on, and also means that distance measurement information can be calculated even if the signal obtained when gate B is on is discarded.

In this way, distance measurement information can be acquired even with a configuration in which the charge holding unit 23-2 located in the center is shared by two pixels 10a.

Since the signal stored in the charge holding unit 23-2 is not used to calculate distance measurement information, a configuration may be provided in which the charge holding unit 23-2 itself is eliminated. However, with the configuration in which the charge holding unit 23-2 is provided between the pixel 10a-1 and the pixel 10a-2, it is possible to achieve a symmetrical structure with respect to a PD 21 for one pixel 10a.

For example, focusing on the pixel 10a-1, it has a configuration in which the PD 21-1 is located at the center, with the charge holding unit 23-1 located to the left of the PD 21-1 and the charge holding unit 23-2 located to the right, resulting in a configuration that is linearly symmetrical with respect to the PD 21-1 as the center. With such a configuration that maintains symmetry, it is possible to improve the accuracy of distance measurement compared to the case of an asymmetric configuration.

As in the pixels 10a illustrated in FIG. 2, with a configuration in which the charge holding unit 23-2 is provided between the adjacent pixels 10a and is shared for signal readout, it is possible to reduce the number of charge holding units, thereby making it possible to miniaturize the pixel 10a.

### Configuration of Pixels 10b According to Second Embodiment

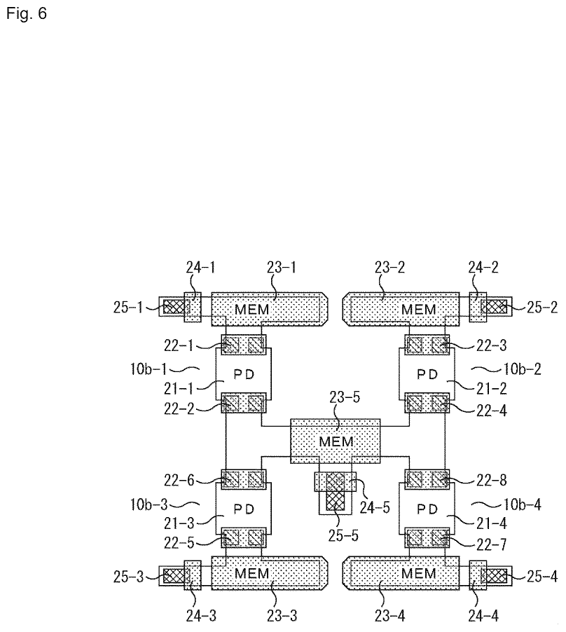

FIG. 6 is a diagram illustrating a planar configuration example of pixels 10b according to a second embodiment.

The pixels 10b according to the second embodiment differ from the pixels 10a (FIG. 2) according to the first embodiment in that a charge holding unit is shared by four pixels 10b. Other points are identical in configuration. In the following description, the same parts as those of the pixels 10a according to the first embodiment are denoted by the same reference signs, and the description thereof will be appropriately omitted.

A pixel 10b-1 includes a PD 21-1, a first transfer transistor 22-1, a first transfer transistor 22-2, a charge holding unit 23-1, a second transfer transistor 24-1, and an FD 25-1. A pixel 10b-2 includes a PD 21-2, a first transfer transistor 22-3, a first transfer transistor 22-4, a charge holding unit 23-2, a second transfer transistor 24-2, and an FD 25-2.

A pixel 10b-3 includes a PD 21-3, a first transfer transistor 22-5, a first transfer transistor 22-6, a charge holding unit 23-3, a second transfer transistor 24-3, and an FD 25-3. A pixel 10b-4 includes a PD 21-4, a first transfer transistor 22-7, a first transfer transistor 22-8, a charge holding unit 23-4, a second transfer transistor 24-4, and an FD 25-4.

A charge holding unit 23-5 is provided at the center of the pixel 10b-1, the pixel 10b-2, the pixel 10b-3, and the pixel 10b-4, and the charge holding unit 23-5 is provided as a charge holding unit shared by the four pixels: the pixel 10b-1, the pixel 10b-2, the pixel 10b-3, and the pixel 10b-4. A second transfer transistor 24-5 and an FD 25-5 are provided below the charge holding unit 23-5 in the figure.

With this configuration, the charge holding unit 23-5 can be shared by the four pixels: the pixel 10b-1, the pixel 10b-2, the pixel 10b-3, and the pixel 10b-4. Even with this configuration, as with the pixels 10a according to the first embodiment, distance measurement information is calculated using the signals stored in the charge holding unit 23-1, the charge holding unit 23-2, the charge holding unit 23-3, and the charge holding unit 23-4, while the signal stored in the charge holding unit 23-5 is not used to calculate distance measurement information.

With the pixels 10b according to the second embodiment as well, it is possible to reduce the number of charge holding units, thereby making it possible to miniaturize the pixel 10b.

### Configuration of Pixels 10c According to Third Embodiment

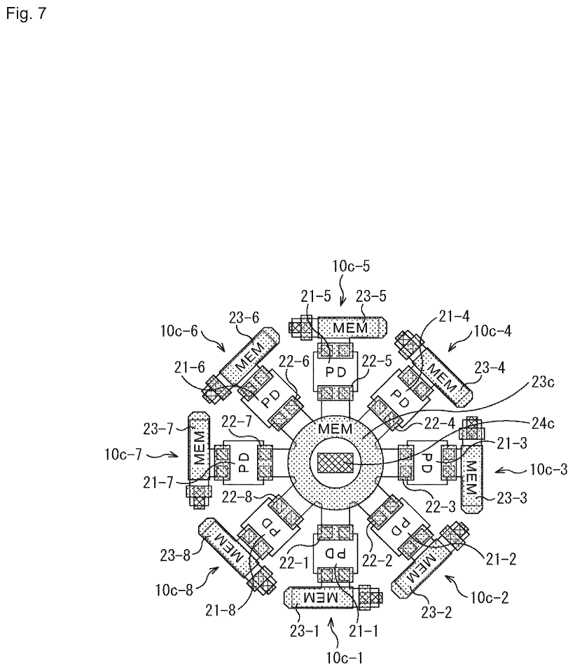

FIG. 7 is a diagram illustrating a planar configuration example of pixels 10c according to a third embodiment.

The pixels 10c according to the third embodiment differ from the pixels 10a according to the first embodiment in that a charge holding unit is shared by eight pixels 10c. Other points are identical in configuration.

A pixel 10c-1 has a configuration including a PD 21-1 and has basically the same configuration as that of the pixel 10a according to the first embodiment. The pixels 10c-2 to 10c-8 also include PDs 21-2 to 21-8, respectively, and each of the pixels 10c-2 to 10-8 has basically the same configuration as the pixel 10a according to the first embodiment.

The pixels 10c-1 to 10c-8 are arranged to surround a shared charge holding unit 23c. The charge holding unit 23c is disposed at the center of the pixels 10c-1 to 10c-8. The charge holding unit 23c is formed in a circular shape, and a second transfer transistor 24c is disposed at the center of the charge holding unit 23c, so that they have a configuration that allows charges to be transferred to an FD 25c not illustrated in FIG. 7.

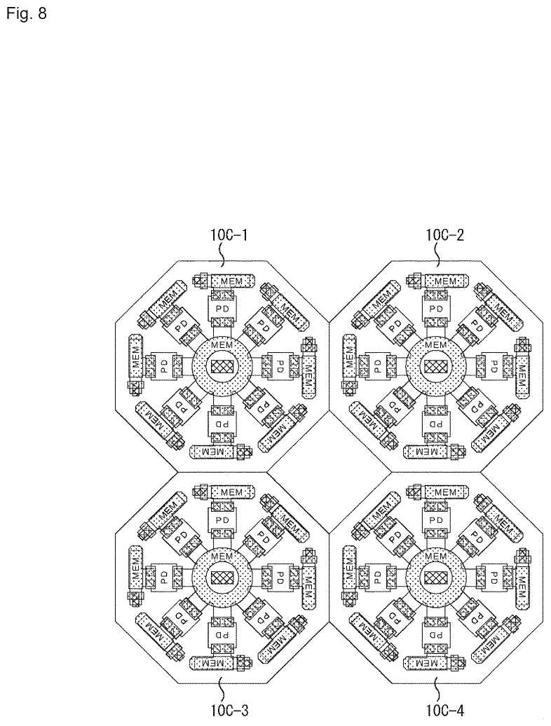

The pixels 10c-1 to 10c-8 are referred to as a pixel group 10C. The pixel group 10C is arranged in the pixel array unit 11 (FIG. 1) as illustrated in FIG. 8. Each pixel group 10C is octagonal, and the octagonal pixel groups 10C are regularly arranged in a matrix on the pixel array unit 11.

In this way, the charge holding unit 23c can be shared by the eight pixels 10c-1 to 10c-8. Even with this configuration, as with the pixels 10a according to the first embodiment, distance measurement information is calculated using the signals stored in each of the charge holding units 23-1 to 23-8, while the signal stored in the charge holding unit 23c is not used to calculate distance measurement information.

With the pixels 10c according to the third embodiment as well, it is possible to achieve a configuration that can reduce the number of charge holding units, thereby making it possible to miniaturize the pixel 10c.

### Configuration of Pixels 10d According to Fourth Embodiment

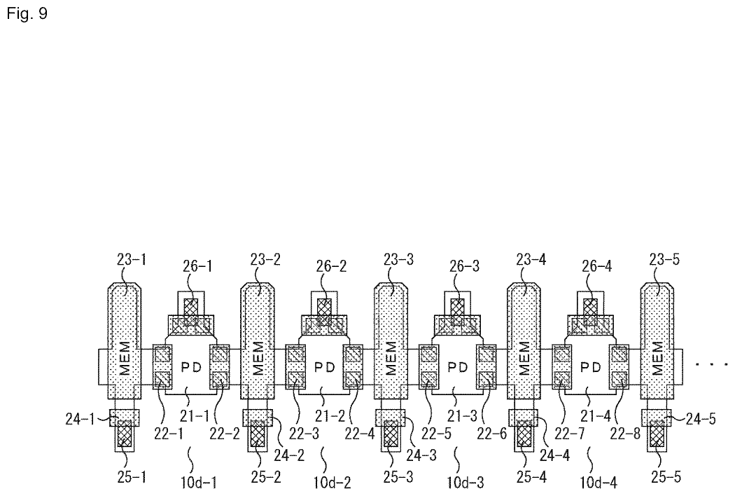

FIG. 9 is a diagram illustrating a planar configuration example of pixels 10d according to a fourth embodiment.

The pixels 10d according to the fourth embodiment differ from the pixels 10a (FIG. 2) according to the first embodiment in that, in the pixels 10d arranged in the transverse direction, adjacent pixels 10d share a charge holding unit therebetween. Other points are identical in configuration. In the pixel 10d according to the fourth embodiment, all the charge holding units arranged in the pixel array unit 11 are configured as charge holding units shared by two adjacent pixels 10d.

In the example illustrated in FIG. 9, four pixels: a pixel 10d-1, a pixel 10d-2, a pixel 10d-3, and a pixel 10d-4 are arranged in the transverse direction. The configuration of each pixel 10d is basically the same as the configuration of the pixel 10a illustrated in FIG. 2.

A charge holding unit 23-1 disposed to the left of the pixel 10d-1 in the figure is shared by the pixel 10d-1 and the left pixel 10d (not illustrated) adjacent to the pixel 10d-1. When a first transfer transistor 22-1 of the pixel 10d-1 is turned on, the charges stored in a PD 21-1 are transferred to the charge holding unit 23-1.

A charge holding unit 23-2 disposed between the pixel 10d-1 and the pixel 10d-2 is shared by the pixel 10d-1 and the pixel 10d-2. A charge holding unit 23-3 disposed between the pixel 10d-2 and the pixel 10d-3 is shared by the pixel 10d-2 and the pixel 10d-3.

A charge holding unit 23-4 disposed between the pixel 10d-3 and the pixel 10d-4 is shared by the pixel 10d-3 and the pixel 10d-4. A charge holding unit 23-5 disposed between the pixel 10d-4 and a pixel 10d-5 (not illustrated) disposed to the right of the pixel 10d-4 in the figure is shared by the pixel 10d-4 and the pixel 10d-5.

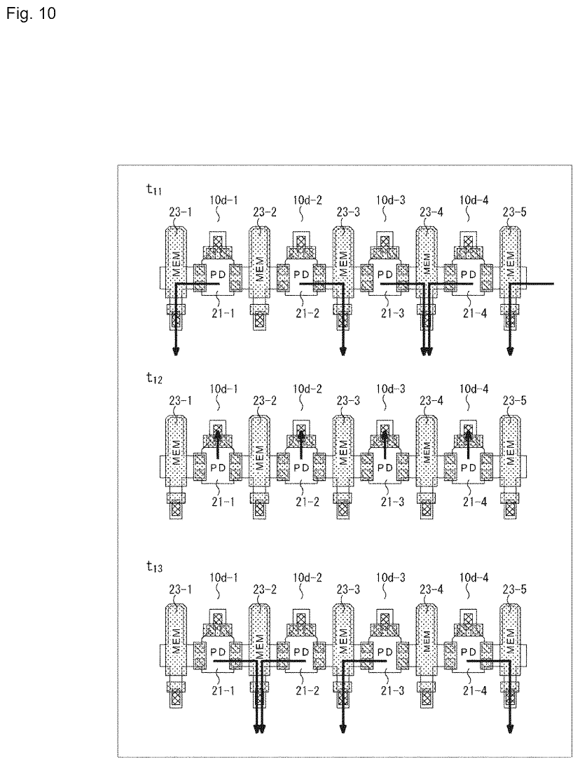

An operation of the pixels 10d illustrated in FIG. 9 will be described with reference to FIG. 10.

In a state t11, signals are read out. In the state t11, the first transfer transistor 22-1 of the pixel 10d-1 is turned on, and the charges stored in a PD 21-1 are transferred to the charge holding unit 23-1, accordingly. The charges transferred to the charge holding unit 23-1 are transferred to an FD 25-1 when a second transfer transistor 24-1 is turned on. Furthermore, a signal is read out from the FD 25-1 to the column processing unit 13 via an amplifier transistor (not illustrated) and so on.

In the state t11, a signal is similarly read out from the pixel 10d-2. A first transfer transistor 22-4 of the pixel 10d-2 is turned on, and the charges stored in a PD 21-2 are transferred to the charge holding unit 23-3, accordingly. The charges transferred to the charge holding unit 23-3 are transferred to an FD 25-3 when a second transfer transistor 24-3 is turned on. Furthermore, a signal is read out from the FD 25-3 to the column processing unit 13 via an amplifier transistor (not illustrated) and so on.

The signals based on the charges transferred to the charge holding unit 23-1 and the charge holding unit 23-2 are used to calculate distance measurement information.

In the state t11, a first transfer transistor 22-6 of the pixel 10d-3 is turned on, and the charges stored in a PD 21-3 are transferred to the charge holding unit 23-4, accordingly. A first transfer transistor 22-7 of the pixel 10d-4 is turned on, and the charges stored in a PD 21-4 are transferred to the charge holding unit 23-4, accordingly.

The charges from the PD 21-3 and the PD 21-4 are transferred to the charge holding unit 23-4. The charges transferred to the charge holding unit 23-4 are transferred to an FD 25-4 when a second transfer transistor 24-4 is turned on. Furthermore, a signal is read out from the FD 25-4 to the column processing unit 13 via an amplifier transistor (not illustrated) and so on.

The charges from the PD 21-3 and the PD 21-4 are transferred to the charge holding unit 23-4, which may result in mixed charges, and therefore, the signal based on the charges transferred to the charge holding unit 23-4 is not used to calculate distance measurement information.

In a state t12, the charges are discharged by a charge discharge transistor 26 of each pixel 10d.

In a state t13, signals are read out. In the state t13, a first transfer transistor 22-2 of the pixel 10d-1 is turned on, a second transfer transistor 24-2 is turned on, and the charges stored in the PD 21-1 are transferred to an FD 25-2 via the charge holding unit 23-2, accordingly.

In the state t13, a first transfer transistor 22-3 of the pixel 10d-2 and the second transfer transistor 24-3 are turned on, and the charges stored in the PD 21-2 are transferred to the FD 25-2 via the charge holding unit 23-2, accordingly.

Since the charges from the PD 21-1 and the PD 21-2 are transferred to the charge holding unit 23-2, the signal based on the charges transferred to the charge holding unit 23-2 is not used to calculate distance measurement information.

In the state t13, a first transfer transistor 22-5 of the pixel 10d-3 is turned on, the second transfer transistor 24-3 is turned on, and the charge stored in the PD 21-3 are transferred to the FD 25-3 via the charge holding unit 23-3, accordingly.

In the state t13, a first transfer transistor 22-8 of the pixel 10d-4 is turned on, a second transfer transistor 24-5 is turned on, and the charges stored in the PD 21-4 are transferred to the FD 25-4 via the charge holding unit 23-5.

The signals based on the charges transferred to the charge holding unit 23-3 and the charge holding unit 23-5 are used to calculate distance measurement information.

After the signals are read out in the state t13, the state transitions to t12, where the charges are discharged by the charge discharge transistor 26 of each pixel 10d. After the charges are discharged, the state returns to t11, where signals are read out. In this way, signal readout and charge discharge are repeated.

Each state is transitioned in synchronization with the driving waveform of an exposure light source.

If, for example, the processing of discharging charges in the state 12 is skipped after the signals are read out in the state t11, and signals are read out in state t13, this may result in mixed signals.

For example, focusing on the charge holding unit 23-3, in the state t11, the charges are transferred from the PD 21-2 and the signal thereof is read out. Thereafter, when the charges from the PD 21-3 are transferred to the charge holding unit 23-3 in the state t13 while there is a possibility that the charges from the PD 21-2 remains in the charge holding unit 23-3, the charges from the PD 21-2 and the charges from the PD 21-3 will be mixed in the charge holding unit 23-3.

Interposing the state t12 makes it possible to prevent such charge mixing.

In the configuration of the pixels 10d described with reference to FIGS. 9 and 10, the charge holding units 23 that store charges of signals used to calculate distance measurement information and the charge holding units 23 that store charges of signals not used to calculate distance measurement information are arranged alternately.

Referring to FIGS. 9 and 10 again, the charge holding unit 23-1, the charge holding unit 23-3, and the charge holding unit 23-5 are the charge holding units 23 that store signals used to calculate distance measurement information. The charge holding unit 23-2 between the charge holding unit 23-1 and the charge holding unit 23-3, and the charge holding unit 23-4 between the charge holding unit 23-3 and the charge holding unit 23-5 are charge holding units 23 that store signals not used to calculate distance measurement information.

With the pixels 10d according to the fourth embodiment as well, it is possible to achieve a configuration that can reduce the number of charge holding units, thereby making it possible to miniaturize the pixel 10d.

### Configuration of Pixels 10e According to Fifth Embodiment

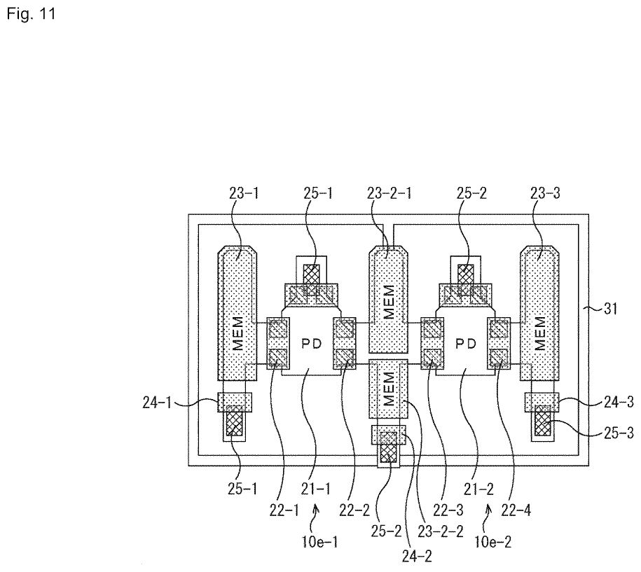

FIG. 11 is a diagram illustrating a planar configuration example of pixels 10e according to a fifth embodiment.

The pixels 10a to 10d according to the first to fourth embodiments have been configured such that the signal from the shared charge holding unit is not used to calculate distance measurement information. The pixels 10e illustrated in FIG. 11 differ from the pixels 10a to 10d according to the first to fourth embodiments in that a signal from a shared charge holding unit is also used to calculate distance measurement information.

The pixels 10e according to the fifth embodiment illustrated in FIG. 11 will be compared with the pixels 10a according to the first embodiment illustrated in FIG. 2. They differ in that the charge holding unit corresponding to the charge holding unit 23-2 of the pixels 10a illustrated in FIG. 2 replaces with a configuration of two charge holding units: a charge holding unit 23-2-1 and a charge holding unit 23-2-2 in the pixels 10e illustrated in FIG. 11. Other points are identical in configuration.

The charge holding unit 23-2 of the pixels 10a illustrated in FIG. 2 is formed in one region, whereas it in the pixels 10e illustrated in FIG. 11 is formed in two regions, the charge holding unit 23-2-1 and the charge holding unit 23-2-2. Although not illustrated in FIG. 11, a transfer transistor that is turned on to hold charges in the charge holding unit 23-2-2 from the charge holding unit 23-2-1 may be provided between the charge holding unit 23-2-1 and the charge holding unit 23-2-2.

Referring to FIG. 11, the charge holding unit 23-2-1 and the charge holding unit 23-2-2 are provided between a pixel 10e-1 and a pixel 10e-2. When a first transfer transistor 22-2 of the pixel 10e-1 is turned on, the charges from a PD 21-1 are transferred to the charge holding unit 23-2-1. Meanwhile a first transfer transistor 22-3 on the PD 21-2 side is in an off state.

The charges from the PD 21-1 transferred to the charge holding unit 23-2-1 are further transferred to the charge holding unit 23-2-2. In this way, the charges from the PD 21-1 are transferred to the charge holding unit 23-2-2 at the second stage via the charge holding unit 23-2-1 at the first stage.

When the charges from the PD 21-1 are transferred to the charge holding unit 23-2-2, the first transfer transistor 22-3 on the PD 21-2 side is turned on, and the charges from the PD 21-2 are transferred to the charge holding unit 23-2-1. Meanwhile the first transfer transistor 22-2 on the PD 21-2 side is in an off state. While the charges are being transferred from the PD 21-2 to the charge holding unit 23-2-1, the charges read out from the PD 21-1 are transferred from the charge holding unit 23-2-2 to an FD 25-2 via a second transfer transistor 24-2.

The charges from the PD 21-2 transferred to the charge holding unit 23-2-1 are further transferred to the charge holding unit 23-2-2. Then, the charges from the PD 21-2 are transferred from the charge holding unit 23-2-2 to the FD 25-2 via the second transfer transistor 24-2. The charges from the PD 21-2 are also transferred to the charge holding unit 23-2-2 at the second stage via the charge holding unit 23-2-1 at the first stage.

In this way, while the first transfer transistor 22-2 of the pixel 10e-1 is on, the first transfer transistor 22-3 of the pixel 10e-2 is off. The charge holding unit including two stages of the charge holding unit 23-2-1 and the charge holding unit 23-2-2 is shared, and the charges from one PD 21 are transferred to the charge holding unit 23-2-1 at the first stage, the charges are transferred from the charge holding unit 23-2-1 at the first stage to the charge holding unit 23-2-2 at the second stage, and then the charges from the other PD 21 are transferred to the charge holding unit 23-2-1 at the first stage.

With such a configuring to be operated, it is possible to prevent the charges from the PD 21-1 and the PD 21-2 from mixing in the shared charge holding unit, so that the signal based on the charges transferred to the shared charge holding unit can also be used to calculate distance measurement information.

According to the fifth embodiment, for the method of calculating distance measurement information with reference to FIG. 5, it is possible to acquire the detection signals B as well, and thus to calculate distance measurement information using the detection signals A and the detection signals B.

With the pixels 10e according to the fifth embodiment as well, since the charge holding unit 23-2 is also configured to be shared, it is possible to achieve a configuration that can reduce the number of charge holding units, thereby making it possible to miniaturize the pixel 10e.

### Configuration of Pixels 10f According to Sixth Embodiment

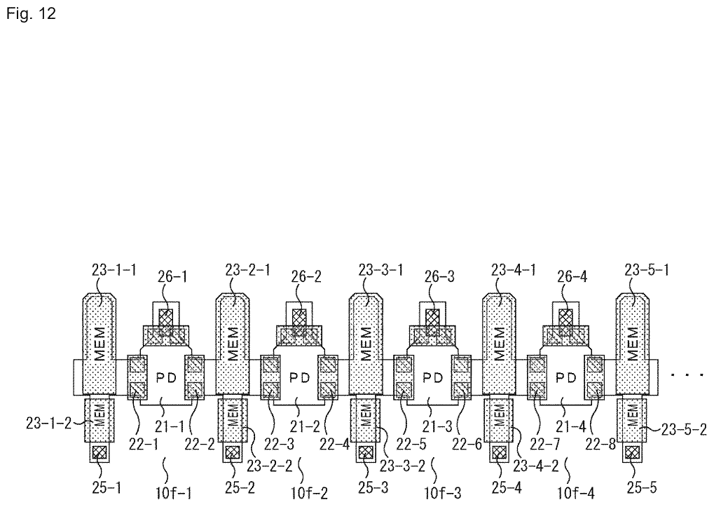

FIG. 12 is a diagram illustrating a planar configuration example of pixels 10f according to a sixth embodiment.

The pixels 10f according to the sixth embodiment illustrated in FIG. 12, as with the pixels 10e according to the fifth embodiment illustrated in FIG. 11, are configured to use a signal from a shared charge holding unit to calculate distance measurement information.

The pixels 10f according to the sixth embodiment illustrated in FIG. 12 will be compared with the pixels 10d according to the fourth embodiment illustrated in FIG. 9. They differ in that the charge holding unit corresponding to each of the charge holding units 23-1 to 23-5 of the pixels 10d illustrated in FIG. 9 replaces with a configuration of charge holding units corresponding to two regions in the pixels 10f illustrated in FIG. 12. Other points are identical in configuration.

A charge holding unit 23-1-1 and a charge holding unit 23-1-2 are provided on the left side of the pixel 10f-1 in the figure. A charge holding unit 23-2-1 and a charge holding unit 23-2-2 are provided between the pixel 10f-1 and a pixel 10f-2. A charge holding unit 23-3-1 and a charge holding unit 23-3-2 are provided between the pixel 10f-2 and a pixel 10f-3.

A charge holding unit 23-4-1 and a charge holding unit 23-4-2 are provided between the pixel 10f-3 and a pixel 10f-4. A charge holding unit 23-5-1 and a charge holding unit 23-5-2 are provided between the pixel 10f-4 and a pixel 10f-5 (not illustrated).

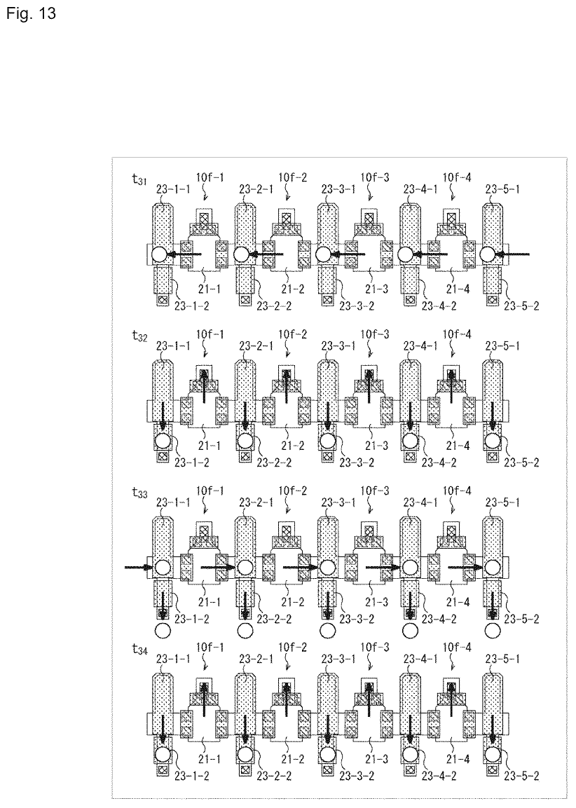

An operation of the pixels 10f illustrated in FIG. 12 will be described with reference to FIGS. 12 and 13.

In a state t31, charges are transferred. A first transfer transistor 22-1 of the pixel 10f-1 is turned on, and charges are transferred from a PD 21-1 to the charge holding unit 23-1-1, accordingly.

A first transfer transistor 22-3 of the pixel 10f-2 is turned on, and charges are transferred from a PD 21-2 to the charge holding unit 23-2-1, accordingly.

A first transfer transistor 22-5 of the pixel 10f-3 is turned on, and charges are transferred from a PD 21-3 to the charge holding unit 23-3-1, accordingly. A first transfer transistor 22-7 of the pixel 10f-4 is turned on, and charges are transferred from a PD 21-4 to the charge holding unit 23-4-1, accordingly.

In the state t31, charges are transferred from the PDs 21 to the charge holding units 23 at the first stage.

In a state t32, charges are discharged and transferred. In the PD 21-1, the charges are discharged by a charge discharge transistor 26-1, and the charges are also transferred from the charge holding unit 23-1-1 to the charge holding unit 23-1-2.

In the PD 21-2, the charges are discharged by a charge discharge transistor 26-2, and the charges are also transferred from the charge holding unit 23-2-1 to the charge holding unit 23-2-2.

In the PD 21-3, the charges are discharged by a charge discharge transistor 26-3, and the charges are also transferred from the charge holding unit 23-3-1 to the charge holding unit 23-3-2.

In the PD 21-4, the charges are discharged by a charge discharge transistor 26-4, and the charges are also transferred from the charge holding unit 23-4-1 to the charge holding unit 23-4-2.

In the state t32, the charges are discharged from the PDs 21, and charges are transferred from the charge holding units 23 at the first stage to the charge holding units 23 at the second stage.

In a state t33, charges are transferred. The charges held in the charge holding unit 23-1-2 are transferred to an FD 25-1 via a second transfer transistor 24-1.

A first transfer transistor 22-2 of the pixel 10f-1 is turned on, and charges are transferred from the PD 21-1 to the charge holding unit 23-2-1, accordingly. The charges held in the charge holding unit 23-2-2 are transferred to an FD 25-2 via a second transfer transistor 24-2.

A first transfer transistor 22-4 of the pixel 10f-2 is turned on, and charges are transferred from the PD 21-2 to the charge holding unit 23-3-1, accordingly. The charges held in the charge holding unit 23-3-2 are transferred to an FD 25-3 via a second transfer transistor 24-3.

A first transfer transistor 22-6 of the pixel 10f-3 is turned on, and charges are transferred from the PD 21-3 to the charge holding unit 23-4-1, accordingly. The charges held in the charge holding unit 23-4-2 are transferred to an FD 25-4 via a second transfer transistor 24-4.

A first transfer transistor 22-8 of the pixel 10f-4 is turned on, and charges are transferred from the PD 21-4 to the charge holding unit 23-5-1, accordingly. The charges held in the charge holding unit 23-5-2 are transferred to an FD 25-5 via a second transfer transistor 24-5.

In the state t33, the charges from the PDs 21 are transferred to the charge holding units 23 at the first stage, and the charges held in the charge holding units 23 at the second stage are transferred to the FDs 25. The signals transferred to the FDs 25 are used to calculate distance measurement information.

In a state t34, charges are discharged and transferred. In the PD 21-1, the charges are discharged by the charge discharge transistor 26-1, and the charges are also transferred from the charge holding unit 23-1-1 to the charge holding unit 23-1-2.

In the PD 21-2, the charges are discharged by the charge discharge transistor 26-2, and the charges are also transferred from the charge holding unit 23-2-1 to the charge holding unit 23-2-2.

In the PD 21-3, the charges are discharged by the charge discharge transistor 26-3, and the charges are also transferred from the charge holding unit 23-3-1 to the charge holding unit 23-3-2.

In the PD 21-4, the charges are discharged by the charge discharge transistor 26-4, and the charges are also transferred from the charge holding unit 23-4-1 to the charge holding unit 23-4-2.

In the state t34, the charges are discharged from the PDs 21, and charges are transferred from the charge holding units 23 at the first stage to the charge holding units 23 at the second stage. The state t34 is essentially the same as the state t32. Returning to the state t31 after the state t34, the processing of transitioning to the state t31 is repeated as described above.

With the pixels 10f according to the sixth embodiment as well, since the charge holding units 23-2 are also configured to be shared, it is possible to miniaturize the pixel 10f. With the pixels 10f according to the sixth embodiment, the signal from the shared charge holding unit can also be used to calculate distance measurement information.

### Configuration of Pixels 10g According to Seventh Embodiment

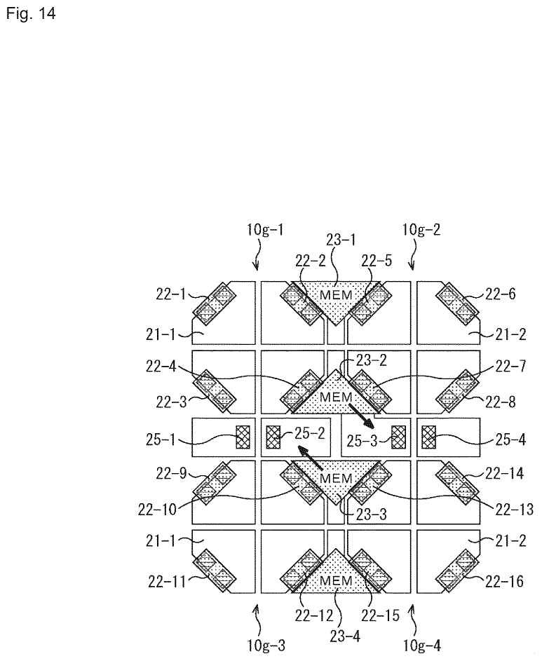

FIG. 14 is a diagram illustrating a planar configuration example of pixels 10g according to a seventh embodiment.

The first to sixth embodiments have been described taking the two-tap method as an example. This technology can also be applied to pixels with a two-tap configuration. The pixels 10g according to the seventh embodiment are illustrated as a planar configuration example of pixels 10g having a four-tap configuration. FIG. 14 illustrates 2 by 2, that is, 4 pixels 10g.

A PD 21-1 is provided in a region near the center of a pixel 10g-1, and first transfer transistors 22-1 to 22-4 are arranged around the PD 21-1. A PD 21-2 is provided in a region near the center of a pixel 10g-2, and first transfer transistors 22-5 to 22-8 are arranged around the PD 21-2.

A PD 21-3 is provided in a region near the center of a pixel 10g-3, and first transfer transistors 22-9 to 22-12 are arranged around the PD 21-3. A PD 21-4 is provided in a region near the center of a pixel 10g-4, and first transfer transistors 22-13 to 22-16 are arranged around the PD 21-4.

The pixel 10g-1 and the pixel 10g-2 share a charge holding unit 23-2. The pixel 10g-3 and the pixel 10g-4 share a charge holding unit 23-4.

An FD 25-1 and an FD 25-2 are provided between the pixel 10g-1 and the pixel 10g-3. An FD 25-3 and an FD 25-4 are provided between the pixel 10g-2 and the pixel 10g-4. Although no second transfer transistor 24 is not illustrated in FIG. 14, second transfer transistors 24 are provided for transferring the charges from the charge holding units 23 to the FDs 25.

The charges from the charge holding unit 23-2 are transferred to the FD 25-3 as indicated by an arrow in the figure. The charges from a charge holding unit 23-3 are transferred to the FD 25-2 as indicated by an arrow in the figure.

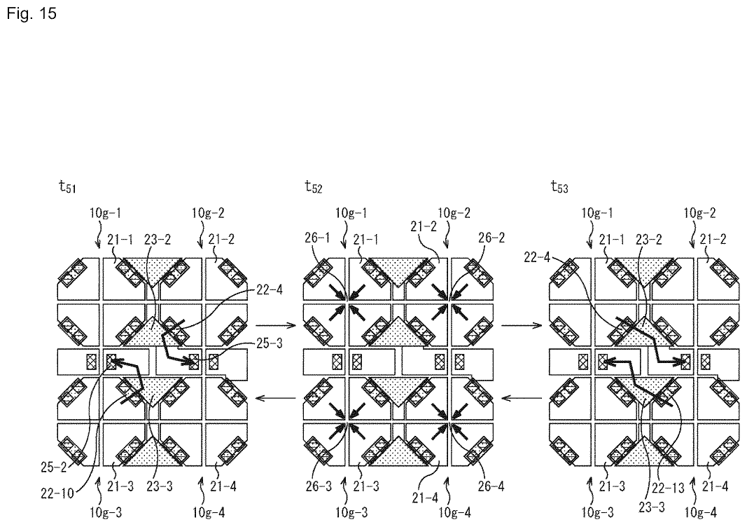

An operation of the pixels 10g illustrated in FIG. 14 will be described with reference to FIGS. 14 and 15.

In a state t51, signals are read out. In the state t51, the first transfer transistor 22-7 of the pixel 10g-2 is turned on, and accordingly, the charges stored in a PD 21-2 are transferred to the charge holding unit 23-2 and then to the FD 25-3 via a second transfer transistor 24 (not illustrated).

The first transfer transistor 22-10 of the pixel 10g-3 is turned on, and accordingly, the charges stored in a PD 21-3 are transferred to the charge holding unit 23-3 and then to the FD 25-2 via a second transfer transistor 24 (not illustrated).

In a state t52, the charges are discharged by a charge discharge transistor 26 of each pixel 10g. For a charge discharge transistor 26-1 (not illustrated) disposed near the center of the PD 21-1, the charges move toward the center and are discharged, as indicated by an arrow in FIG. 15. Similarly, in the PDs 21-2 to 21-4, charges are discharged by charge discharge transistors 26-2 to 26-4 (not illustrated), respectively.

In a state t53, signals are read out. In the state t53, the first transfer transistor 22-4 of the pixel 10g-1 is turned on, and accordingly, the charges stored in the PD 21-1 are transferred to the charge holding unit 23-2 and then to the FD 25-3 via a second transfer transistor 24 (not illustrated).

The first transfer transistor 22-13 of the pixel 10g-4 is turned on, and accordingly, the charges stored in the PD 21-4 are transferred to the charge holding unit 23-3 and then to the FD 25-2 via a second transfer transistor 24 (not illustrated).

After the signals are read out in the state t53, the state transitions to t52, where the charges are discharged by the charge discharge transistor 26 of each pixel 10g. After the charges are discharged, the state returns to t51, where signals are read out. In this way, signal readout and charge discharge are repeated.

Each state is transitioned in synchronization with the driving waveform of an exposure light source.

With the pixels 10g according to the seventh embodiment as well, they have a configuration in which the charge holding units are shared, so that it is possible to reduce the number of charge holding units, thereby making it possible to miniaturize the pixel 10g. In addition, as in the seventh embodiment, the present technology can also be applied to pixels that perform distance measurement with a four-tap configuration.

### Configuration of Pixels 10h According to Eighth Embodiment

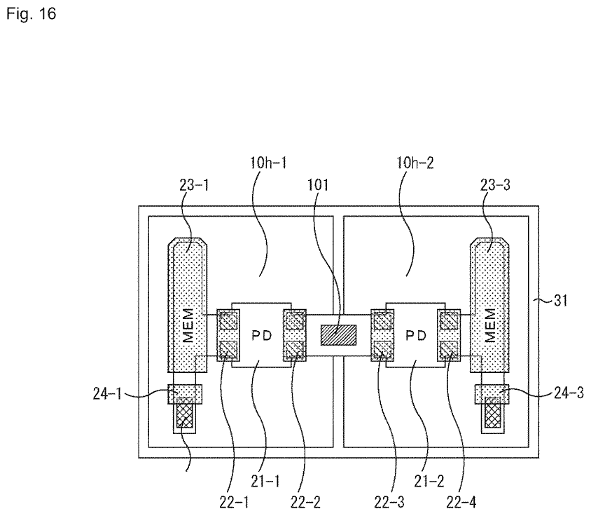

FIG. 16 is a diagram illustrating a planar configuration example of pixels 10h according to an eighth embodiment.

The pixels 10h according to the eighth embodiment have the same basic configuration as that of the pixels 10a according to the first embodiment (FIG. 2), and differ in that what is shared is a region to which a power source and the like are connected, instead of a charge holding unit.

The pixels 10h illustrated in FIG. 16 differ in that the charge holding unit 23-2, the second transfer transistor 24-2, and the FD 25-2 are eliminated from the pixels 10a illustrated in FIG. 2, and a wiring region 101 is disposed in the region where they have been eliminated.

A first transfer transistor 22-2 is connected to the wiring region 101, and configured to transfer the charges from a PD 21-1 to the wiring region 101 when the first transfer transistor 22-2 enters an on state. A first transfer transistor 22-3 is connected to the wiring region 101, and configured to transfer the charges from a PD 21-2 to the wiring region 101 when the first transfer transistor 22-3 enters a on state.

The wiring region 101 is connected to a power supply with a predetermined voltage. Alternatively, the wiring region 101 may be configured to be grounded. The charges transferred to the wiring region 101 are discharged. In order to efficiently discharge the charges, the wiring region 101 may be configured to be connected to a power supply with a predetermined voltage.

The wiring region 101 may also be configured as a charge discharge transistor 26 (FIG. 2). In the pixels 10h illustrated in FIG. 16, the wiring region 101 is used in place of the charge discharge transistor 26, and it can also be said that this is a configuration in which the charge discharge transistor 26 connected to the PD 21 of the pixel 10a illustrated in FIG. 2 is eliminated.

In this way, the wiring region 101 connected to the power supply (or grounded) can be configured to be shared by two adjacent pixels 10h. Even with this configuration, distance measurement information can be calculated. With the pixels 10h illustrated in FIG. 16, the wiring region 101 can be configured to be small, and the charge discharge transistor 26 (FIG. 2) can be disposed in the wiring region 101, making it possible to further miniaturize the pixel 10h.

### Configuration of Pixels 10i According to Ninth Embodiment

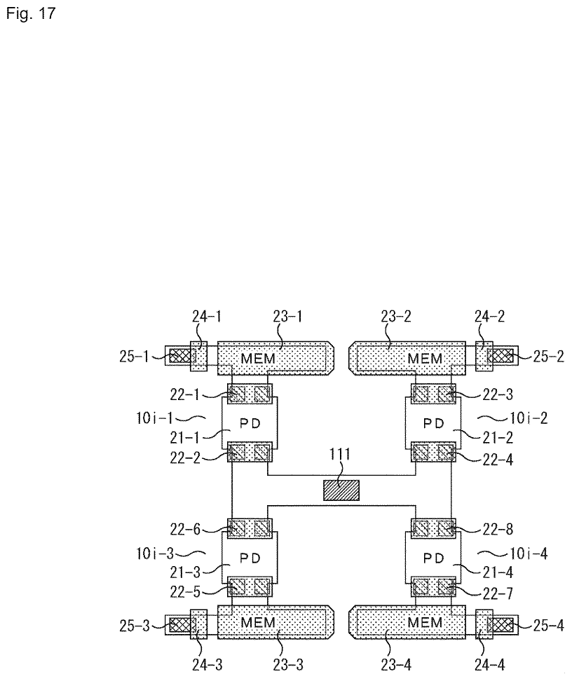

FIG. 17 is a diagram illustrating a planar configuration example of pixels 10i according to a ninth embodiment.

The pixels 10h according to the eighth embodiment have the same basic configuration as that of the pixels 10b according to the second embodiment (FIG. 6), and differ in that what is shared is a region to which a power source and the like are connected, instead of a charge holding unit.

The pixels 10i illustrated in FIG. 17 differ in that the charge holding unit 23-5, the second transfer transistor 24-5, and the FD 25-5 are eliminated from the pixels 10b illustrated in FIG. 6, and a wiring region 111 is disposed in the region where they have been eliminated.

A first transfer transistor 22-2, a first transfer transistor 22-4, a first transfer transistor 22-6, and a first transfer transistor 22-8 are each connected to the wiring region 111, and configured so that, when they are turned on, the charges from PDs 21-1 to 21-4 are transferred to the wiring region 111.

The wiring region 111 is connected to a power supply with a predetermined voltage. Alternatively, the wiring region 111 may be configured to be grounded. The charges transferred to the wiring region 111 are discharged. In order to efficiently discharge the charges, the wiring region 111 may be configured to be connected to a power supply with a predetermined voltage. The wiring region 111 may be configured as a charge discharge transistor 26 (FIG. 2).

In this way, the wiring region 111 connected to the power supply can be configured to be shared by the four adjacent pixels 10i. Even with this configuration, distance measurement information can be calculated. With the pixels 10i illustrated in FIG. 17, the wiring region 111 can be configured to be small, and the charge discharge transistor 26 can be disposed, making it possible to further miniaturize the pixel 10i.

### Configuration of Pixels 10i According to Tenth Embodiment

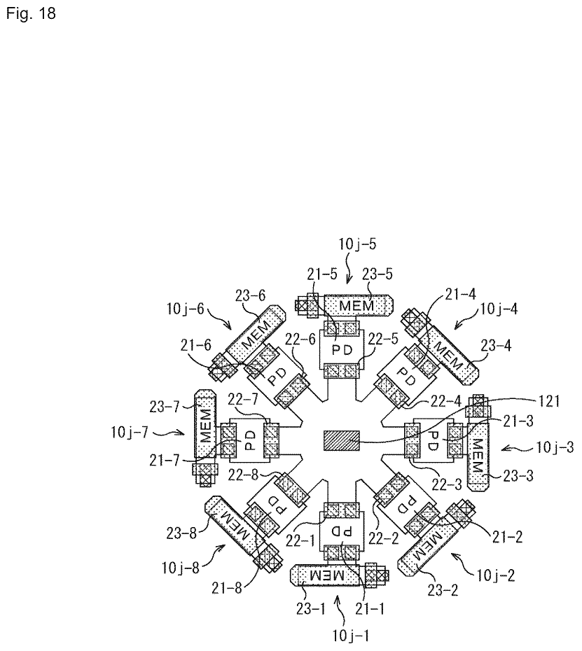

FIG. 18 is a diagram illustrating a planar configuration example of pixels 10j according to a tenth embodiment.

The pixels 10j according to the eighth embodiment have the same basic configuration as that of the pixels 10c according to the third embodiment (FIG. 7), and differ in that what is shared is a region to which a power source and the like are connected, instead of a charge holding unit.

The pixels 10j illustrated in FIG. 18 differ in that the charge holding unit 23c, the second transfer transistor 24c, and the FD 25c (not illustrated in FIG. 3) are eliminated from the pixels 10c illustrated in FIG. 7, and a wiring region 121 is disposed in the region where they have been eliminated.

First transfer transistors 22-1 to 22-8 are each connected to the wiring region 121, and configured to transfer the charges from PDs 21-1 to 21-8 to the wiring region 121 when the first transfer transistors 22-1 to 22-8 enter an on state.

The wiring region 121 is connected to a power supply with a predetermined voltage. Alternatively, the wiring region 121 may be configured to be grounded. The charges transferred to the wiring region 121 are discharged. In order to efficiently discharge the charges, the wiring region 121 may be configured to be connected to a power supply with a predetermined voltage. The wiring region 121 may be configured as a charge discharge transistor 26 (FIG. 2).

In this way, the wiring region 121 connected to the power supply can be configured to be shared by the eight pixels 10j surrounding the wiring region 121. Even with this configuration, distance measurement information can be calculated. With the pixels 10j illustrated in FIG. 18, the wiring region 121 can be configured to be small, and the charge discharge transistor 26 can be disposed, making it possible to further miniaturize the pixel 10j.

The present technology makes it possible to reduce the space occupied by the charge holding unit(s) per pixel compared to conventional pixel structures, and makes it possible to achieve fine pixels while roughly maintaining pixel characteristics such as the amount of saturated electrons and transfer performance. Furthermore, the number of charge holding units is reduced and the drive is simplified, thereby making it possible to reduce power consumption.

### Configuration Example of Distance Measurement Module

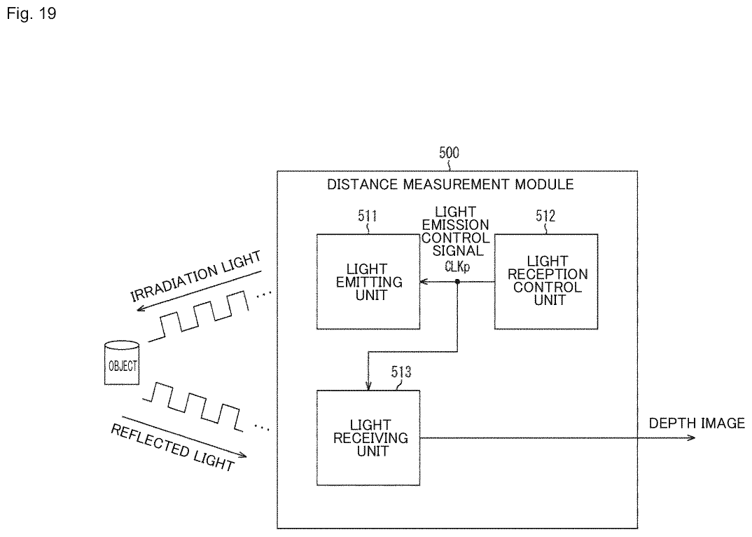

FIG. 19 is a block diagram illustrating a configuration example of a distance measurement module that outputs distance measurement information using the above-described light receiving element 1.

A distance measurement module 500 includes a light emitting unit 511, a light emission control unit 512, and a light receiving unit 513.

The light emitting unit 511 includes a light source that emits light having a predetermined wavelength, and irradiates an object with irradiation light of which a brightness varies periodically. For example, the light emitting unit 511 includes a light emitting diode that emits infrared light with a wavelength of 780 nm or more as a light source, and generates irradiation light in synchronization with a light emission control signal CLKp of a rectangular wave supplied from the light emission control unit 512.

Note that the light emission control signal CLKp is not limited to a rectangular wave as long as it is a periodic signal. For example, the light emission control signal CLKp may be a sine wave.

The light emission control unit 512 supplies the light emission control signal CLKp to the light emitting unit 511 and the light receiving unit 513 and controls an irradiation timing of irradiation light. The frequency of the light emission control signal CLKp is, for example, 20 megahertz (MHz). The frequency of the light emission control signal CLKp is not limited to 20 megahertz and may be 5 megahertz, 100 megahertz, or the like.

The light receiving unit 513 receives reflected light reflected from an object, calculates distance information for each pixel in accordance with a result of light reception, and generates and outputs a depth image in which a depth value corresponding to a distance to the object (subject) is stored as a pixel value.

As the light receiving unit 513, the light receiving element 1 having the pixel structure of the indirect ToF method described above can be used.

### Configuration Example of Electronic Device

As described above, the light receiving element 1 can be applied to a distance measurement module, and can also be applied to various electronic devices such as, for example, imaging devices such as digital still cameras and digital video cameras equipped with a distance measurement function, and smartphones having a distance measurement function.

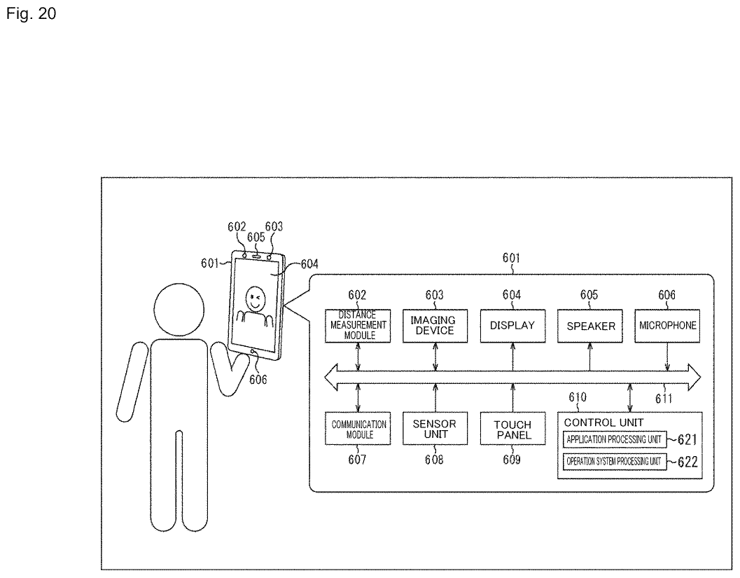

FIG. 20 is a block diagram illustrating a configuration example of a smartphone as an electronic device to which the present technology is applied.

As illustrated in FIG. 20, a smartphone 601 is configured such that a distance measurement module 602, an imaging device 603, a display 604, a speaker 605, a microphone 606, a communication module 607, a sensor unit 608, a touch panel 609, and a control unit 610 are connected to each other via a bus 611. Further, the control unit 610 has functions as an application processing unit 621 and an operation system processing unit 622 by a CPU executing a program.

The distance measurement module 500 illustrated in FIG. 19 is applied to the distance measurement module 602. For example, the distance measurement module 602 is disposed on a front surface of the smartphone 601 and, by performing distance measurement with a user of the smartphone 601 as an object, the distance measurement module 602 can output a depth value of a surface shape of the face, a hand, a finger, or the like of the user as a distance measurement result.

The imaging device 603 is disposed on the front surface of the smartphone 601 and, by capturing an image of the user of the smartphone 601 as a subject, acquires the image in which the user appears. Although not illustrated, a configuration in which the imaging device 603 is also disposed on the back surface of the smartphone 601 may be adopted.

The display 604 displays an operation screen for performing processing by the application processing unit 621 and the operation system processing unit 622, an image captured by the imaging device 603, and the like. The speaker 605 and the microphone 606 perform, for example, output of sound from a counterpart and collection of user's sound when making a call using the smartphone 601.

The communication module 607 performs network communication through a communication network such as the Internet, a public telephone network, a wide area communication network for wireless mobile bodies such as a so-called 4G line and 5G line, a wide area network (WAN), and local area network (LAN), short-range wireless communication such as Bluetooth (registered trademark) and near field communication (NFC), and the like. The sensor unit 608 senses a speed, acceleration, proximity, and the like, and the touch panel 609 acquires a user's touch operation on the operation screen displayed on the display 604.

The application processing unit 621 performs processing for providing various services through the smartphone 601. For example, the application processing unit 621 can perform processing of creating a face by computer graphics that virtually reproduces the user's facial expression on the basis of a depth value supplied from the distance measurement module 602 and displaying the created face on the display 604. In addition, the application processing unit 621 can perform processing of creating, for example, three-dimensional shape data of an arbitrary three-dimensional object on the basis of a depth value supplied from the distance measurement module 602.

The operation system processing unit 622 performs processing for realizing basic functions and operations of the smartphone 601. For example, the operation system processing unit 622 can perform processing for authenticating a user's face on the basis of a depth value supplied from the distance measurement module 602, and unlocking the smartphone 601. In addition, the operation system processing unit 622 can perform, for example, processing for recognizing a user's gesture on the basis of a depth value supplied from the distance measurement module 602, and can perform processing for inputting various operations according to the gesture.

In the smartphone 601 configured in this manner, applying the distance measurement module 500 described above as the distance measurement module 602 enables performing, for example, processing for measuring and displaying a distance to a predetermined object, creating and displaying three-dimensional shape data of a predetermined object, and the like.

### <Application to Moving Body>

The technology of the present disclosure (the present technology) can be applied to various products. For example, the technology according to the present disclosure may be realized as a device mounted on any type of moving body such as an automobile, an electric automobile, a hybrid electric automobile, a motorcycle, a bicycle, a personal mobility device, an airplane, a drone, a ship, a robot, or the like.

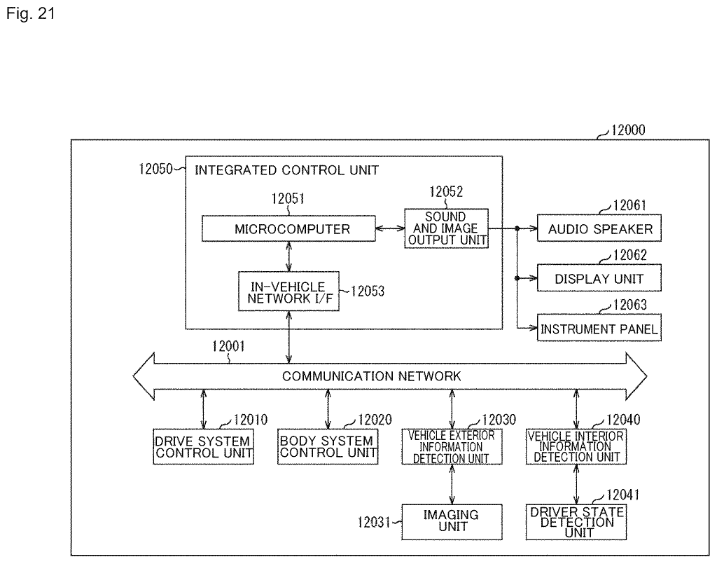

FIG. 21 is a block diagram illustrating a schematic configuration example of a vehicle control system that is an example of a mobile object control system to which the technology according to the present disclosure can be applied.

A vehicle control system 12000 includes a plurality of electronic control units connected to one another via a communication network 12001. In the example illustrated in FIG. 21, the vehicle control system 12000 includes a drive system control unit 12010, a body system control unit 12020, a vehicle exterior information detection unit 12030, a vehicle interior information detection unit 12040, and an integrated control unit 12050. A microcomputer 12051, a sound and image output unit 12052, and an in-vehicle network I/F (Interface) 12053 are illustrated as the functional configuration of the integrated control unit 12050.

The drive system control unit 12010 controls an operation of a device related to a drive system of a vehicle according to various programs. For example, the drive system control unit 12010 functions as a control device such as: a driving force generation device for generating a driving force of a vehicle such as an internal combustion engine or a driving motor; a driving force transmission mechanism for transmitting a driving force to wheels; a steering mechanism for adjusting a turning angle of a vehicle; and a braking device that generates a braking force of a vehicle.

The body system control unit 12020 controls operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives inputs of the radio waves or signals and controls a door lock device, a power window device, and a lamp of the vehicle.

The vehicle exterior information detection unit 12030 detects information on the outside of the vehicle having the vehicle control system 12000 mounted thereon. For example, an imaging unit 12031 is connected to the vehicle exterior information detection unit 12030. The vehicle exterior information detection unit 12030 causes the imaging unit 12031 to capture an image of the outside of the vehicle and receives the captured image. The vehicle exterior information detection unit 12030 may perform object detection processing or distance detection processing for people, cars, obstacles, signs, and letters on the road on the basis of the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or invisible light such as infrared light.

The vehicle interior information detection unit 12040 detects information on the inside of the vehicle. For example, a driver state detection unit 12041 that detects a driver's state is connected to the vehicle interior information detection unit 12040. The driver state detection unit 12041 includes, for example, a camera that captures an image of a driver, and the vehicle interior information detection unit 12040 may calculate a degree of fatigue or concentration of the driver or may determine whether or not the driver is dozing on the basis of detection information input from the driver state detection unit 12041.

The microcomputer 12051 can calculate control target values for the driving force generation device, the steering mechanism, or the braking device based on information on the inside and outside of the vehicle, the information being acquired by the vehicle exterior information detection unit 12030 or the vehicle interior information detection unit 12040, and the microcomputer 12051 can output control commands to the drive system control unit 12010. For example, the microcomputer 12051 can perform cooperative control to implement the functions of an advanced driver assistance system (ADAS) including vehicle collision avoidance, impact mitigation, following traveling based on an inter-vehicle distance, vehicle speed maintenance driving, vehicle collision warning, and vehicle lane deviation warning.

Further, the microcomputer 12051 can perform cooperative control for the purpose of automated driving or the like in which autonomous travel is performed without depending on operations of the driver, by controlling the driving force generation device, the steering mechanism, or the braking device and the like on the basis of information about the surroundings of the vehicle, the information being acquired by the vehicle exterior information detection unit 12030 or the vehicle interior information detection unit 12040.

In addition, the microcomputer 12051 can output a control command to the body system control unit 12030 based on the information outside the vehicle acquired by the vehicle exterior information detection unit 12030. For example, the microcomputer 12051 can perform coordinated control for the purpose of antiglare such as switching a high beam to a low beam by controlling a headlamp according to a position of a preceding vehicle or an oncoming vehicle detected by the vehicle exterior information detection unit 12030.

The sound and image output unit 12052 transmits an output signal of at least one of sound and an image to an output device capable of visually or audibly notifying a passenger or the outside of the vehicle of information. In the example of FIG. 21, an audio speaker 12061, a display unit 12062, and an instrument panel 12063 are illustrated as examples of the output device. The display unit 12062 may include at least one of an on-board display and a head-up display, for example.

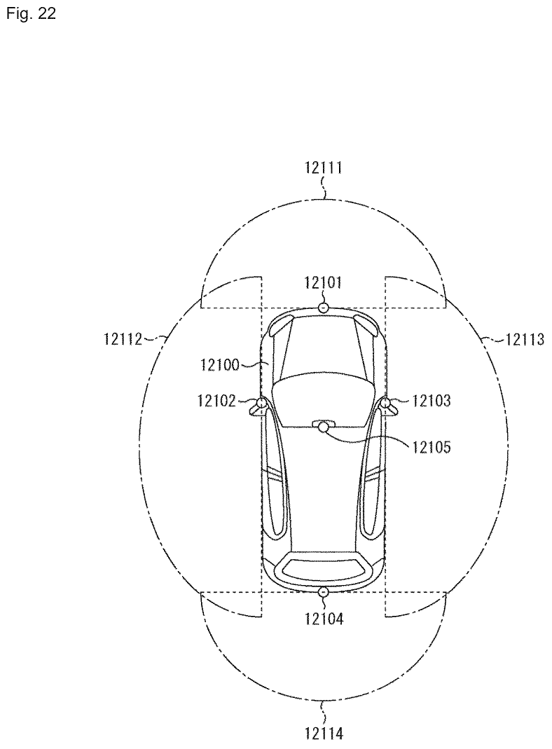

FIG. 22 is a diagram illustrating an example of installation positions of imaging units 12031.

In FIG. 22, the imaging unit 12031 includes imaging units 12101, 12102, 12103, 12104, and 12105.

The imaging units 12101, 12102, 12103, 12104, and 12105 are provided at, for example, positions of a front nose, side mirrors, a rear bumper, a back door, an upper portion of a vehicle internal front windshield, and the like of the vehicle 12100. The imaging unit 12101 provided on a front nose and the imaging unit 12105 provided in an upper portion of the vehicle internal front windshield mainly acquire images in front of the vehicle 12100. The imaging units 12102 and 12103 provided in the side mirrors mainly acquire images on the lateral sides of the vehicle 12100. The imaging unit 12104 included in the rear bumper or the back door mainly acquires an image of an area behind the vehicle 12100. The imaging unit 12105 included in the upper portion of the windshield inside the vehicle is mainly used for detection of a preceding vehicle, a pedestrian, an obstacle, a traffic signal, a traffic sign, a lane, or the like.

FIG. 22 illustrates an example of imaging ranges of the imaging units 12101 to 12104. An imaging range 12111 indicates an imaging range of the imaging unit 12101 provided at the front nose, imaging ranges 12112 and 12113 respectively indicate the imaging ranges of the imaging units 12102 and 12103 provided at the side-view mirrors, and an imaging range 12114 indicates the imaging range of the imaging unit 12104 provided at the rear bumper or the back door. For example, by superimposing image data captured by the imaging units 12101 to 12104, it is possible to obtain a bird's-eye view image viewed from the upper side of the vehicle 12100.

At least one of the imaging units 12101 to 12104 may have a function for obtaining distance information. For example, at least one of the imaging units 12101 to 12104 may be a stereo camera constituted by a plurality of imaging elements or may be an imaging element that has pixels for phase difference detection.

For example, the microcomputer 12051 can extract, particularly, the closest three-dimensional object on a path through which the vehicle 12100 is traveling, which is a three-dimensional object traveling at a predetermined speed (for example, 0 km/h or higher) in the substantially same direction as the vehicle 12100, as a preceding vehicle by obtaining a distance to each three-dimensional object in the imaging ranges 12111 to 12114 and temporal change in the distance (a relative speed with respect to the vehicle 12100) based on distance information obtained from the imaging units 12101 to 12104. The microcomputer 12051 can also set a following distance to the preceding vehicle to be maintained in advance and perform automatic brake control (including following stop control) and automatic acceleration control (including following start control). It is therefore possible to perform coordinated control for, for example, automated driving in which the vehicle travels in an automated manner without requiring the driver to perform operations.

For example, the microcomputer 12051 can classify and extract three-dimensional data regarding three-dimensional objects into two-wheeled vehicles, normal vehicles, large vehicles, pedestrians, and other three-dimensional objects such as electric poles based on distance information obtained from the imaging units 12101 to 12104 and can use the three-dimensional data to perform automated avoidance of obstacles. For example, the microcomputer 12051 differentiates surrounding obstacles of the vehicle 12100 into obstacles which can be viewed by the driver of the vehicle 12100 and obstacles which are difficult to view. Then, the microcomputer 12051 determines a collision risk indicating the degree of risk of collision with each obstacle, and when the collision risk is equal to or higher than a set value and there is a possibility of collision, an alarm is output to the driver through the audio speaker 12061 or the display unit 12062, forced deceleration or avoidance steering is performed through the drive system control unit 12010, and thus it is possible to perform driving support for collision avoidance.

At least one of the imaging units 12101 to 12104 may be an infrared camera that detects infrared rays. For example, the microcomputer 12051 can recognize a pedestrian by determining whether there is a pedestrian in the captured image of the imaging units 12101 to 12104. Such pedestrian recognition is performed by, for example, a procedure in which feature points in the captured images of the imaging units 12101 to 12104 as infrared cameras are extracted and a procedure in which pattern matching processing is performed on a series of feature points indicating an outline of an object to determine whether or not the object is a pedestrian. When the microcomputer 12051 determines that there is a pedestrian in the captured images of the imaging units 12101 to 12104 and the pedestrian is recognized, the sound and image output unit 12052 controls the display unit 12062 so that a square contour line for emphasis is superimposed and displayed with the recognized pedestrian. In addition, the sound and image output unit 12052 may control the display unit 12062 so that an icon indicating a pedestrian or the like is displayed at a desired position.

The system as used herein refers to an entire device configured by a plurality of devices.

The effects described in the present specification are merely examples and are not limited, and other effects may be obtained.

Embodiments of the present technology are not limited to the above-described embodiments and various modifications can be made without departing from the scope and spirit of the present technology.

The present technology can also be configured as follows.

(1)

A light receiving element including:
a pixel array unit in which pixels each including a photoelectric conversion unit are arranged in a matrix; and
a charge holding unit that holds charges from the photoelectric conversion unit, wherein
in each of the pixels, a first charge holding unit in which a signal based on the held charges is used to calculate distance measurement information and a second charge holding unit in which the signal is not used to calculate distance measurement information are arranged.
   (2)

The light receiving element according to (1), wherein the second charge holding unit is disposed between the photoelectric conversion units adjacent to each other and is shared by the adjacent photoelectric conversion units.

(3)

The light receiving element according to (1) or (2), wherein the first charge holding unit is disposed on one of the photoelectric conversion units, and the second charge holding unit is disposed on another of the photoelectric conversion units.

(4)

The light receiving element according to any one of (1) to (3), wherein charges are transferred to the second charge holding unit from each of the photoelectric conversion units adjacent to each other.

(5)

The light receiving element according to any one of (1) to (4), wherein the first charge holding unit and the second charge holding unit are each shared by adjacent photoelectric conversion units.

(6)

The light receiving element according to any one of (1) to (5), wherein the first charge holding unit and the second charge holding unit are provided in plurality to be arranged alternately.

(7)

The light receiving element according to any one of (1) to (6), wherein the second charge storage unit is shared by two, four, or eight pixels.

(8)

The light receiving element according to (1) or (7), wherein a region in which the second charge holding unit is disposed is a region for discharging charges.

(9)

An electronic device including:
a light receiving element that includes
a pixel array unit in which pixels each including a photoelectric conversion unit are arranged in a matrix, and
a charge holding unit that holds charges from the photoelectric conversion unit, wherein in each of the pixels, a first charge holding unit in which a signal based on the held charges is used to calculate distance measurement information and a second charge holding unit in which the signal is not used to calculate distance measurement information are arranged; and
a processing unit that processes a signal from the light receiving element.
   (10)

A light receiving element including:
a pixel array unit in which pixels each including a photoelectric conversion unit are arranged in a matrix; and
a charge holding unit that holds charges from the photoelectric conversion unit, wherein
the charge holding unit is shared by the photoelectric conversion units adjacent to each other, and
in the pixel array unit, first charge holding units each configured of one region and second charge holding units each configured of two regions are arranged alternately.
   (11)

The light receiving element according to (10), wherein charges from the photoelectric conversion unit are transferred to the second charge holding unit at a first stage, and are then transferred from the second charge holding unit at the first stage to the second charge holding unit at a second stage.

(12)

The light receiving element according to (10) or (11), wherein distance measurement information is generated from a signal based on charges held in the first charge holding unit and the second charge holding unit.

(13)

An electronic device including:
a light receiving element that includes
a pixel array unit in which pixels each including a photoelectric conversion unit are arranged in a matrix, and
a charge holding unit that holds charges from the photoelectric conversion unit, wherein the charge holding unit is shared by the photoelectric conversion units adjacent to each other, and in the pixel array unit, first charge holding units each configured of one region and second charge holding units each configured of two regions are arranged alternately; and
a processing unit that processes a signal from the light receiving element.
   (14)

A light receiving element including:
a pixel array unit in which pixels each including a photoelectric conversion unit are arranged in a matrix; and
a charge holding unit that holds charges from the photoelectric conversion unit, wherein
the charge holding unit is shared by the photoelectric conversion units adjacent to each other and is configured of two regions.
   (15)

The light receiving element according to (14), wherein charges from the photoelectric conversion unit are transferred to the charge holding unit at a first stage, and are then transferred from the charge holding unit at the first stage to the charge holding unit at a second stage.

(16)

An electronic device including:
a light receiving element that includes a pixel array unit in which pixels each including a photoelectric conversion unit are arranged in a matrix, and
a charge holding unit that holds charges from the photoelectric conversion unit, wherein
the charge holding unit is shared by the photoelectric conversion units adjacent to each other and is configured of two regions; and
a processing unit that processes a signal from the light receiving element.

### REFERENCE SIGNS LIST

1 Light receiving element
10 Pixel
11 Pixel array unit
12 Vertical drive unit
13 Column processing unit
14 Horizontal drive unit
15 System control unit
16 Signal processing unit
17 Data storage unit
18 Pixel drive line
19 Vertical signal line
22 First transfer transistor
23 Charge holding unit
24 Second transfer transistor
26 Charge discharge transistor
27 Amplifier transistor
28 Selection transistor
29 Reset transistor
40 Semiconductor substrate
41 Semiconductor region
42 Oxide film
43 Light shielding film
44 Flattened film
45 On-chip lens
101 Wiring region
111 Wiring region
121 Wiring region

1. A light receiving element comprising:
a pixel array unit in which pixels each including a photoelectric conversion unit are arranged in a matrix; and
a charge holding unit that holds charges from the photoelectric conversion unit, wherein
in each of the pixels, a first charge holding unit in which a signal based on the held charges is used to calculate distance measurement information and a second charge holding unit in which the signal is not used to calculate distance measurement information are arranged.

2. The light receiving element according to claim 1, wherein the second charge holding unit is disposed between the photoelectric conversion units adjacent to each other and is shared by the adjacent photoelectric conversion units.

3. The light receiving element according to claim 1, wherein the first charge holding unit is disposed on one of the photoelectric conversion units, and the second charge holding unit is disposed on another of the photoelectric conversion units.

4. The light receiving element according to claim 1, wherein charges are transferred to the second charge holding unit from each of the photoelectric conversion units adjacent to each other.

5. The light receiving element according to claim 1, wherein the first charge holding unit and the second charge holding unit are each shared by adjacent photoelectric conversion units.

6. The light receiving element according to claim 1, wherein the first charge holding unit and the second charge holding unit are provided in plurality to be arranged alternately.

7. The light receiving element according to claim 1, wherein the second charge storage unit is shared by two, four, or eight pixels.

8. The light receiving element according to claim 1, wherein a region in which the second charge holding unit is disposed is a region for discharging charges.

9. An electronic device comprising:
a light receiving element that includes
a pixel array unit in which pixels each including a photoelectric conversion unit are arranged in a matrix, and
a charge holding unit that holds charges from the photoelectric conversion unit,
wherein, in each of the pixels, a first charge holding unit in which a signal based on the held charges is used to calculate distance measurement information and a
second charge holding unit in which the signal is not used to calculate distance measurement information are arranged; and
a processing unit that processes a signal from the light receiving element.

10. A light receiving element comprising:
a pixel array unit in which pixels each including a photoelectric conversion unit are arranged in a matrix; and
a charge holding unit that holds charges from the photoelectric conversion unit, wherein
the charge holding unit is shared by the photoelectric conversion units adjacent to each other, and
in the pixel array unit, first charge holding units each configured of one region and second charge holding units each configured of two regions are arranged alternately.

11. The light receiving element according to claim 10, wherein charges from the photoelectric conversion unit are transferred to the second charge holding unit at a first stage, and are then transferred from the second charge holding unit at the first stage to the second charge holding unit at a second stage.

12. The light receiving element according to claim 10, wherein distance measurement information is generated from a signal based on charges held in the first charge holding unit and the second charge holding unit.

13. An electronic device comprising:
a light receiving element that includes
a pixel array unit in which pixels each including a photoelectric conversion unit are arranged in a matrix, and
a charge holding unit that holds charges from the photoelectric conversion unit,
wherein the charge holding unit is shared by the photoelectric conversion units adjacent to each other, and in the pixel array unit, first charge holding units each configured of one region and second charge holding units each configured of two regions are arranged alternately; and
a processing unit that processes a signal from the light receiving element.

14. A light receiving element comprising:
a pixel array unit in which pixels each including a photoelectric conversion unit are arranged in a matrix; and
a charge holding unit that holds charges from the photoelectric conversion unit, wherein
the charge holding unit is shared by the photoelectric conversion units adjacent to each other and is configured of two regions.

15. The light receiving element according to claim 14, wherein charges from the photoelectric conversion unit are transferred to the charge holding unit at a first stage, and are then transferred from the charge holding unit at the first stage to the charge holding unit at a second stage.

16. An electronic device comprising:
a light receiving element that includes
a pixel array unit in which pixels each including a photoelectric conversion unit are arranged in a matrix, and
a charge holding unit that holds charges from the photoelectric conversion unit,
wherein the charge holding unit is shared by the photoelectric conversion units adjacent to each other and is configured of two regions; and
a processing unit that processes a signal from the light receiving element.
